(19) United States
(12) Patent Application Publication
(10) Pub. No.: US 2026/0304354 A1
(43) Pub. Date: Oct. 1, 2026

(54) 60 GIGAHERTZ NULL DATA PACKET SOUNDING

(71) Applicant: QUALCOMM Incorporated, San Diego, CA (US)

(72) Inventors: Lin YANG, San Diego, CA (US); Bin TIAN, San Diego, CA (US); Tzu-Hsuan CHOU, San Diego, CA (US); Youhan KIM, Saratoga, CA (US); Jialing Li CHEN, San Diego, CA (US)

(21) Appl. No.: 19/392,011

(22) Filed: Nov. 17, 2025

Related U.S. Application Data
(60) Provisional application No. 63/778,191, filed on Mar. 26, 2025.

(51) Int. Cl. H04W 64/00; H04L 5/00; H04W 16/28

(52) U.S. Cl. CPC H04W 64/00; H04L 5/0053; H04W 16/28

(57) ABSTRACT

This disclosure provides methods, components, devices and systems for 60 gigahertz (GHz) null data packet (NDP) sounding. Some aspects more specifically relate to using an NDP frame for 60 GHz channel sounding to perform analog beam training and digital beamforming channel sounding. An initiator device, such as a wireless access point (AP), may transmit a first set of NDP frames for a channel sounding procedure via a 60 GHz wireless channel. A responder device may measure the first set of NDP frames and transmit a second set of NDP frames via the 60 GHz wireless channel. The sounding procedure may include a 1-dimensional (1D) or two-dimensional (2D) beam search procedure. In some examples, the sounding procedure may be assisted by a sub-7 GHz communication link.

### CROSS REFERENCES

The present Application for Patent claims benefit of U.S. Provisional Patent Application No. 63/778,191 by YANG et al., entitled “60 GIGAHERTZ NULL DATA PACKET SOUNDING,” filed Mar. 26, 2025, assigned to the assignee hereof, and expressly incorporated herein.

### TECHNICAL FIELD

This disclosure relates generally to wireless communication and, more specifically, to 60 gigahertz null data packet sounding.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a wireless access point (AP). The method may include outputting, via at least a portion of a first wireless channel associated with a 60 GHz communication band, a first set of multiple null data packet frames that correspond to a first set of multiple beams of the wireless AP for a sounding procedure, obtaining, via at least the portion of the first wireless channel associated with the 60 GHz communication band, a second set of multiple null data packet frames that correspond to a second set of multiple beams of a wireless station for the sounding procedure, and outputting beam information that indicates at least a first beam of the first set of multiple beams or a second beam of the second set of multiple beams, or both, based on the sounding procedure.

Another innovative aspect of the subject matter described in this disclosure can be implemented in a method for wireless communications by a wireless AP. The method may include transmitting, via at least a portion of a first wireless channel associated with a 60 GHz communication band, a first set of multiple null data packet frames that correspond to a first set of multiple beams of the wireless AP for a sounding procedure, receiving, via at least the portion of the first wireless channel associated with the 60 GHz communication band, a second set of multiple null data packet frames that correspond to a second set of multiple beams of a wireless station for the sounding procedure, and transmitting beam information that indicates at least a first beam of the first set of multiple beams or a second beam of the second set of multiple beams, or both, based on the sounding procedure.

Another innovative aspect of the subject matter described in this disclosure can be implemented in a wireless AP for wireless communications. The wireless AP may include a processing system that includes processor circuitry and memory circuitry that stores code. The processing system may be configured to cause the wireless AP to output, via at least a portion of a first wireless channel associated with a 60 GHz communication band, a first set of multiple null data packet frames that correspond to a first set of multiple beams of the wireless AP for a sounding procedure, obtain, via at least the portion of the first wireless channel associated with the 60 GHz communication band, a second set of multiple null data packet frames that correspond to a second set of multiple beams of a wireless station for the sounding procedure, and output beam information that indicates at least a first beam of the first set of multiple beams or a second beam of the second set of multiple beams, or both, based on the sounding procedure.

Another innovative aspect of the subject matter described in this disclosure can be implemented in a wireless AP for wireless communications. The wireless AP may include a processing system that includes processor circuitry, memory circuitry that stores code and a transceiver. The processing system may be configured to cause the wireless AP to transmit, via the transceiver and via at least a portion of a first wireless channel associated with a 60 GHz communication band, a first set of multiple null data packet frames that correspond to a first set of multiple beams of the wireless AP for a sounding procedure, receive, via the transceiver and via at least the portion of the first wireless channel associated with the 60 GHz communication band, a second set of multiple null data packet frames that correspond to a second set of multiple beams of a wireless station for the sounding procedure, and transmit, via the transceiver, beam information that indicates at least a first beam of the first set of multiple beams or a second beam of the second set of multiple beams, or both, based on the sounding procedure.

Another innovative aspect of the subject matter described in this disclosure can be implemented in a wireless AP for wireless communications. The wireless AP may include means for outputting, via at least a portion of a first wireless channel associated with a 60 GHz communication band, a first set of multiple null data packet frames that correspond to a first set of multiple beams of the wireless AP for a sounding procedure, means for obtaining, via at least the portion of the first wireless channel associated with the 60 GHz communication band, a second set of multiple null data packet frames that correspond to a second set of multiple beams of a wireless station for the sounding procedure, and means for outputting beam information that indicates at least a first beam of the first set of multiple beams or a second beam of the second set of multiple beams, or both, based on the sounding procedure.

Another innovative aspect of the subject matter described in this disclosure can be implemented in a non-transitory computer-readable medium storing code for wireless communications. The code may include instructions executable by one or more processors to output, via at least a portion of a first wireless channel associated with a 60 GHz communication band, a first set of multiple null data packet frames that correspond to a first set of multiple beams of the wireless AP for a sounding procedure, obtain, via at least the portion of the first wireless channel associated with the 60 GHz communication band, a second set of multiple null data packet frames that correspond to a second set of multiple beams of a wireless station for the sounding procedure, and output beam information that indicates at least a first beam of the first set of multiple beams or a second beam of the second set of multiple beams, or both, based on the sounding procedure.

Another innovative aspect of the subject matter described in this disclosure can be implemented in a method for wireless communications by a wireless station. The method may include receiving, via at least a portion of a first wireless channel associated with a 60 GHz communication band, a first set of multiple null data packet frames that correspond to a first set of multiple beams of a wireless AP for a sounding procedure, transmitting, via at least the portion of the first wireless channel associated with the 60 GHz communication band, a second set of multiple null data packet frames that correspond to a second set of multiple beams of the wireless station for the sounding procedure, and receiving beam information that indicates at least a first beam of the first set of multiple beams or a second beam of the second set of multiple beams, or both, based on the sounding procedure.

Another innovative aspect of the subject matter described in this disclosure can be implemented in wireless station for wireless communications. The wireless station may include a processing system that includes processor circuitry and memory circuitry that stores code. The processing system may be configured to cause the wireless station to receive, via at least a portion of a first wireless channel associated with a 60 GHz communication band, a first set of multiple null data packet frames that correspond to a first set of multiple beams of a wireless AP for a sounding procedure, transmit, via at least the portion of the first wireless channel associated with the 60 GHz communication band, a second set of multiple null data packet frames that correspond to a second set of multiple beams of the wireless station for the sounding procedure, and receive beam information that indicates at least a first beam of the first set of multiple beams or a second beam of the second set of multiple beams, or both, based on the sounding procedure.

Another innovative aspect of the subject matter described in this disclosure can be implemented in wireless station for wireless communications. The wireless station may include means for receiving, via at least a portion of a first wireless channel associated with a 60 GHz communication band, a first set of multiple null data packet frames that correspond to a first set of multiple beams of a wireless AP for a sounding procedure, means for transmitting, via at least the portion of the first wireless channel associated with the 60 GHz communication band, a second set of multiple null data packet frames that correspond to a second set of multiple beams of the wireless station for the sounding procedure, and means for receiving beam information that indicates at least a first beam of the first set of multiple beams or a second beam of the second set of multiple beams, or both, based on the sounding procedure.

Another innovative aspect of the subject matter described in this disclosure can be implemented in non-transitory computer-readable medium storing code for wireless communications. The code may include instructions executable by one or more processors to receive, via at least a portion of a first wireless channel associated with a 60 GHz communication band, a first set of multiple null data packet frames that correspond to a first set of multiple beams of a wireless AP for a sounding procedure, transmit, via at least the portion of the first wireless channel associated with the 60 GHz communication band, a second set of multiple null data packet frames that correspond to a second set of multiple beams of the wireless station for the sounding procedure, and receive beam information that indicates at least a first beam of the first set of multiple beams or a second beam of the second set of multiple beams, or both, based on the sounding procedure.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows a frequency diagram depicting an example distributed tone mapping.

FIG. 6 shows an example of a beam search procedure that supports 60 gigahertz (GHz) null data packet (NDP) sounding.

FIG. 7 shows an example of a beam search procedure that supports 60 GHz NDP sounding.

FIG. 8 shows an example of a beam search procedure that supports 60 GHz NDP sounding.

FIG. 9 shows an example of a beam search procedure that supports 60 GHz NDP sounding.

FIG. 10 shows an example of a PPDU format that supports 60 GHz NDP sounding.

FIG. 11 shows an example of a PPDU format that supports 60 GHz NDP sounding.

FIG. 12 shows an example of an NDP frame format that supports 60 GHz NDP sounding.

FIG. 13 shows an example of a process flow that supports 60 GHz NDP sounding.

FIG. 14 shows a block diagram of an example wireless communication device that supports 60 GHz NDP sounding.

FIG. 15 shows a block diagram of an example wireless communication device that supports 60 GHz NDP sounding.

FIGS. 16 through 18 show flowcharts illustrating example processes performable by or at a wireless AP that supports 60 GHz NDP sounding.

FIG. 19 shows a flowchart illustrating an example process performable by or at a wireless station that supports 60 GHz NDP sounding.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, a wireless station (STA) and an access point (AP) may communicate training signals for an analog beam training procedure on a wireless channel associated with a 60 GHz communication band. In some cases, the STA and the AP may perform a two-dimensional (2D) beam search and scan over all beam pairs between directional transmit beams and directional receive beams. For example, the AP may transmit a set of training signals using each transmit beam of the AP, and the STA may receive one set of training signals using each receive beam of the STA. Then, the STA may transmit a set of training signals using each transmit beam of the STA, and the AP may receive one set of training signals using each receive beam of the AP, providing full beamforming gain information between the beams of the AP and the STA. In some cases, the STA and the AP may perform a one-dimensional (1D) beam search, where a transmitting device transmits training signals using all directional transmit beams in a sector pointing toward a receiving device, and the receiving device receives the training signals using a quasi-omni directional receive beam (for example, a wide receive beam). The 2D beam search may provide full beamforming gain information (from both the transmit beams and the receive beams) but have greater overhead. In some cases, the STA and the AP may separately perform a digital beamforming channel sounding using NDP sounding and sounding feedback procedure similar to that in sub 7 GHz to obtain channel sounding information for the 60 GHz wireless channel between the STA and the AP with both transmission and reception using the best beam pair obtained from the analog beam training. Performing these techniques without optimization of the sounding sequence and NDP format may result in high training overhead and reduced spectral utilization.

Various aspects relate generally to 60 GHz channel sounding. Some aspects more specifically relate to using a null data packet (NDP) frame for 60 GHz channel sounding to perform analog beam training and digital beamforming channel sounding. In some examples, an AP and a STA may communicate via a wireless channel associated with a 60 GHz communication band. The AP may transmit a first set of NDP frames for a channel sounding procedure via the wireless channel associated with the 60 GHz communication band. The STA may receive the first set of NDP frames and transmit a second set of NDP frames for the channel sounding procedure to the AP via the wireless channel associated with the 60 GHz communication band. The AP may transmit sector-level sweep (SLS) information or channel state information (CSI) that indicates channel sounding information or beam information, or both, based on the channel sounding procedure. In some examples, the AP and the STA may also use a sub-7 GHz wireless channel associated with a sub-7 GHz communication band to assist the training procedure. In some examples, the AP may transmit, and the STA may receive, an NDP announcement (NDPA) frame on the sub-7 GHz wireless channel that indicates information for the 60 GHz NDP channel sounding procedure. In some examples, the STA may transmit SLS or CSI after receiving the first set of NDP frames for the channel sounding procedure. Example formats for an NDP frame used for 60 GHz channel sounding are described.

Particular aspects of the subject matter described in this disclosure can be implemented to realize one or more of the following potential advantages. In some examples, by performing a 60 GHz channel sounding procedure using optimized sounding sequences and NDP frames, the described techniques can be used to perform both analog beam training and digital beamforming channel sounding, with reduced overhead and increasing spectral efficiency.

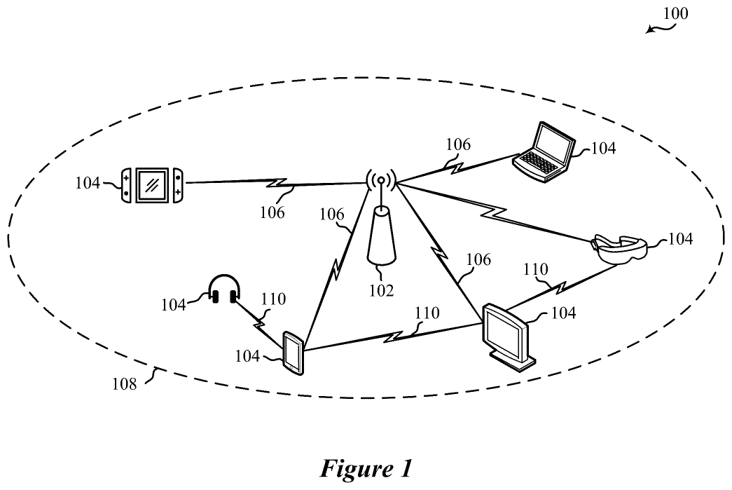

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR-or IEEE 802.11bn-compatible) devices for opportunistic access to spectrum that may be otherwise under-utilized.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and Ultra-High Reliability (UHR) operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log signal-to-noise ratio (SNR) trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while a UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

In some wireless communication systems, wireless communication devices (such as an AP 102 and STAs 104 described with reference to FIG. 1) may operate via one or more wireless communication links in a frequency band higher than a sub-7 GHz (sub 7, such as a 2.4 GHz frequency band, a 5 GHz frequency band, or a 6 GHz frequency band) frequency band. In some such wireless communication systems, the AP 102 and STAs 104 may communicate on a wireless communication link in a millimeter wave (“mmWave” or “mmW”) band (for example, a frequency band between 30 GHz and 300 GHz, such as a 60 GHz frequency band). A wireless communication system supporting such mmWave communications (such as AP 102 and STAs 104 in wireless communications network 100) may use integrated mmWave (IMMW) techniques to support operations in these frequency bands. To manage the relatively high attenuation losses and other path losses associated with the mmWave band, the AP 102 and STAs 104 may transmit and receive directional communications via beamforming procedures. To select or otherwise generate directional beams in the mmWave band, a wireless communication device may perform beam sweeping, searching and training operations, which may involve various training and feedback reporting packet sequences. In some wireless communication systems, a mmWave link supports data communications while a sub7 link may be used for management and control information signaling to support the mmWave communications. For example, a STA 104 may first associate with an AP 102 to establish a sub7 link, and thereafter, perform beam searching and training in the mmWave band to establish a mmWave link for the communication of data. In such examples, the sub7 link may be referred to as an anchor link.

In addition to beam searching and training procedures, an AP 102 and a STA 104, after having selected a beam pair, may perform beam management and recovery procedures, including periodic beacon-based procedures and aperiodic STA-initiated fast link recovery procedures, which may involve the use of beam recovery sequences. The AP 102 and STAs 104 may use these beam management and recovery procedures for beam sync-up and identifying broken links. When communicating via a mmWave link, the AP 102 and STAs 104 may perform various channel access procedures including contention-based access procedures, target wake time (TWT)-based access procedures (including the use of dedicated and opportunistic service periods (SPs)), scheduled-mode access procedures, and triggered-mode access procedures. The APs 102 and STAs 104 operating in the mmWave band also may support various management frame optimizations and procedures including optimizations and procedures associated with discovery, scanning, association, roaming, link setup, updates and maintenance, and the initial and continuing configuration of BSS and link-specific parameters including channel selection and rate adaptation. To support or facilitate communication in the mmWave band, the APs 102 and STAs 104 also may make use of various PHY layer enhancements, such as additional bandwidth modes, numerologies, tone plans, preamble designs, codebook designs, waveform designs, new PPDU formats or reuse of existing sub-7 GHz PPDU formats for mmWave frequencies. Particular RF and analog designs, such as RF front end designs, antenna integration designs, and conversion architecture designs, may be implemented in APs 102 and STAs 104 to support mmWave operation.

An initiator device, such as an AP 102, and a responder device, such as a STA 104, may perform a sounding procedure using multiple NDP frames on a first wireless channel associated with a 60 GHz communication band. For example, the AP 102 may transmit a first set of NDP frames via the first wireless channel, and the STA 104 may measure the first set of NDP frames. The STA 104 may transmit a second set of NDP frames via the wireless channel, and the AP 102 may measure the second set of NDP frames. The sounding procedure may include a beam search procedure which uses 1D beam scanning or 2D beam scanning. For example, a transmitting device may transmit a set of NDP frames, where each NDP frame is transmitted using a different transmit beam of the transmitting device. For a 1D beam scanning, the receiving device may receive the set of NDP frames using a quasi-omnidirectional receive beam. For a 2D beam scanning, the transmitting device may transmit the set of NDP frames multiple times, once for each receive beam of the receiving device. In some examples, a 2D beam scanning may include a receiver-side SLS or a receiver-side BRP within a same transmit beam direction, which may be repeated or scanned over all transmission sectors of the transmitter (for example, all beam directions of the transmitter).

An NDP frame used for the sounding procedure may be formatted according to an NDP format or a PPDU format described herein. Additionally, the transmitter may transmit an NDP for the sounding procedure using an NDP bandwidth as described herein. A STA 104 and an AP 102 may communicate SLS information or CSI, or both, to indicate beam information as described herein. In some examples, the sounding process may include use of second wireless channel associated with a sub-7 GHz communication band, for example to communicate control information (such as via an NDPA frame) including parameters for the sounding procedure or timing/frequency reference information, or both.

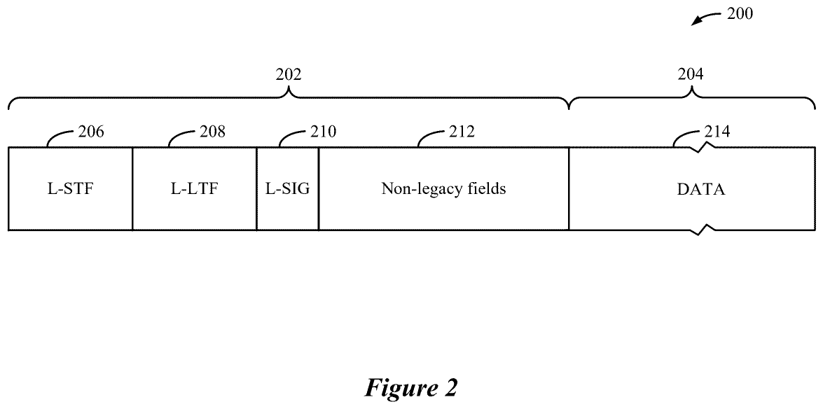

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

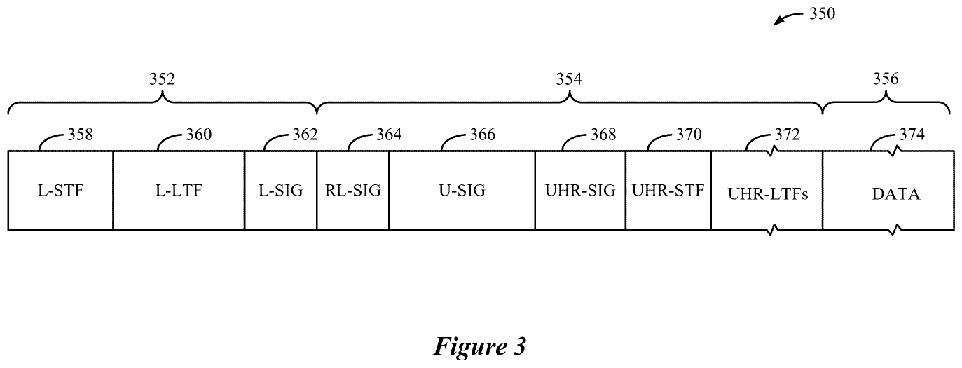

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364, a universal signal field 366 (referred to herein as “U-SIG 366”) and a UHR signal field 368 (referred to herein as “UHR-SIG 368”). The presence of RL-SIG 364 and U-SIG 366 may indicate to UHR or later version-compliant STAs 104 that the PPDU 350 is a UHR PPDU or a PPDU conforming to any later (post-UHR) version of a new wireless communication protocol conforming to a future IEEE 802.11 wireless communication protocol standard. One or both of U-SIG 366 and UHR-SIG 368 may be structured as, and carry version-dependent information for, other wireless communication protocol versions associated with amendments to the IEEE family of standards beyond UHR. For example, U-SIG 366 may be used by a receiving device (such as an AP 102 or a STA 104) to interpret bits in one or more of UHR-SIG 368 or the data field 374. U-SIG 366 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 366 and UHR-SIG 368 and additional information fields or single user (SU)-specific fields that may be useful to intended recipients. In some implementations, the version-dependent fields may include at least a PPDU format field to indicate a general PPDU format for the PPDU 350 (such as a trigger-based (TB), a single-user (SU), or a multi-user (MU) PPDU format). Like L-STF 358, L-LTF 360, and L-SIG 362, the information in U-SIG 366 and UHR-SIG 368 may be duplicated and transmitted in each of the component 20 MHz channels in instances involving the use of a bonded channel.

The non-legacy portion 354 further includes an additional short training field 370 (referred to herein as “UHR-STF 370,” although it may be structured as, and carry version-dependent information for, other wireless communication protocol versions beyond UHR) and one or more additional long training fields 372 (referred to herein as “UHR-LTFs 372,” although they may be structured as, and carry version-dependent information for, other wireless communication protocol versions beyond UHR). UHR-STF 370 may be used for timing and frequency tracking and AGC, and UHR-LTF 372 may be used for more refined channel estimation.

UHR-SIG 368 may be used by an AP 102 to identify and inform one or multiple STAs 104 that the AP 102 has scheduled uplink (UL) or downlink (DL) resources for them. UHR-SIG 368 may be decoded by each compatible STA 104 served by the AP 102. UHR-SIG 368 also may generally be used by the receiving device to interpret bits in the data field 374. For example, UHR-SIG 368 may include resource unit (RU) allocation information, spatial stream configuration information, and per-user (for example, STA-specific) signaling information. Each UHR-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some wireless communications systems, a STA 104 or an AP 102 may transmit the PPDU 350 over bandwidths larger than the 20 MHz, 40 MHz, 80 MHz, 160 MHz, and 320 MHz bandwidths supported by previous generations of IEEE-compliant wireless communication systems. For example, the PPDU 350 may support 480 MHz or 640 MHz bandwidth communications. By increasing the channel bandwidth of the PPDU 350 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 370, UHR-LTFs 372, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different SNRs), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 366 of an ELR PPDU 350 may include a first indication (for example, a codepoint of a PHY version identifier subfield within a version-independent portion of the U-SIG 366 or a value of an ELR subfield within a version-dependent portion of the U-SIG 366) that the PPDU 350 is associated with an ELR format. The U-SIG 366 of an ELR PPDU 350 may include a second indication (for example, a STA identifier subfield within the version-dependent portion of the U-SIG 366) of an intended receiver of the PPDU. In some examples, an ELR PPDU 350 may include an ELR-signature (ELR-SIG) field that includes an uplink/downlink indicator subfield, a length subfield, a coding indicator subfield, and a modulation and coding scheme (MCS) subfield.

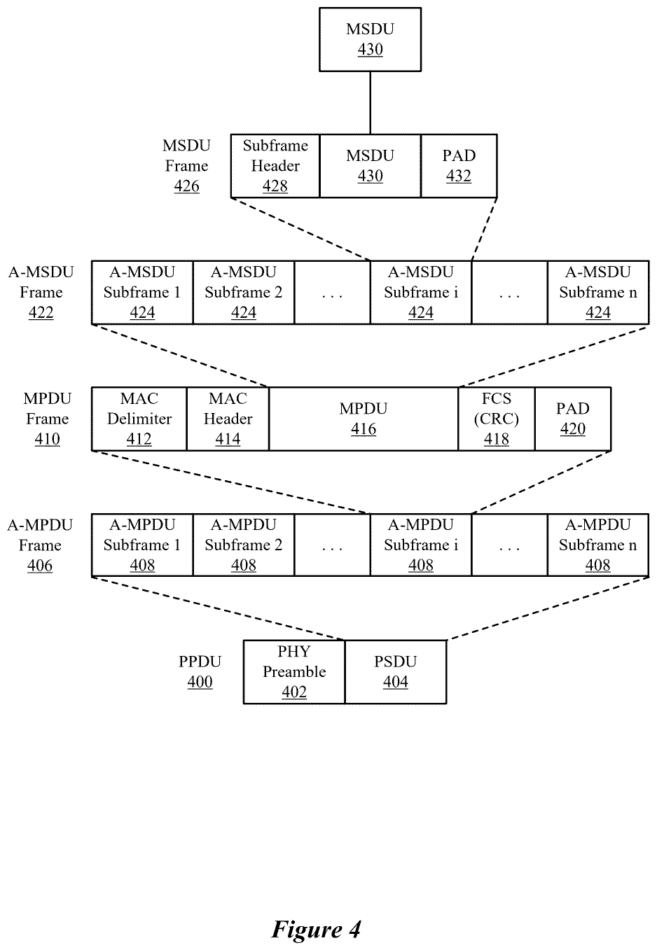

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 408 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (for example, the FCS field 418 may include a cyclic redundancy check (CRC)) and padding bits 420. The MPDU 416 may carry one or more MAC service data units (MSDUs) 430. For example, the MPDU 416 may carry an aggregated MSDU (A-MSDU) 422 including multiple A-MSDU subframes 424. Each A-MSDU subframe 424 may be associated with an MSDU frame 426 and may contain a corresponding MSDU 430 preceded by a subframe header 428 and, in some examples, followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 414 also includes one or more fields indicating addresses for the data encapsulated within the frame body. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields.

APs and STAs (for example, the AP 102 and the STAs 104 described with reference to FIG. 1) that include multiple antennas may support various diversity schemes. For example, spatial diversity may be used by one or both of a transmitting device (such as an AP 102 or a STA 104) or a receiving device (such as an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number N_{STS} of space-time streams, which are mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a SNR, as well as in a multi-user (MU) context, for example, to enable MU-MIMO transmissions (also referred to as spatial division multiple access (SDMA)). In the MU-MIMO context, beamforming may additionally, or alternatively, involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (for example, in the form of an NDP) to the beamformee. An NDP is a PPDU without any data field. The beamformee may perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (for example, identify, detect, ascertain, calculate, or compute) how to transmit a signal on each of its antennas to perform beamforming. For example, the steering matrix may be indicative of a phase shift, or a power level, to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communications to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

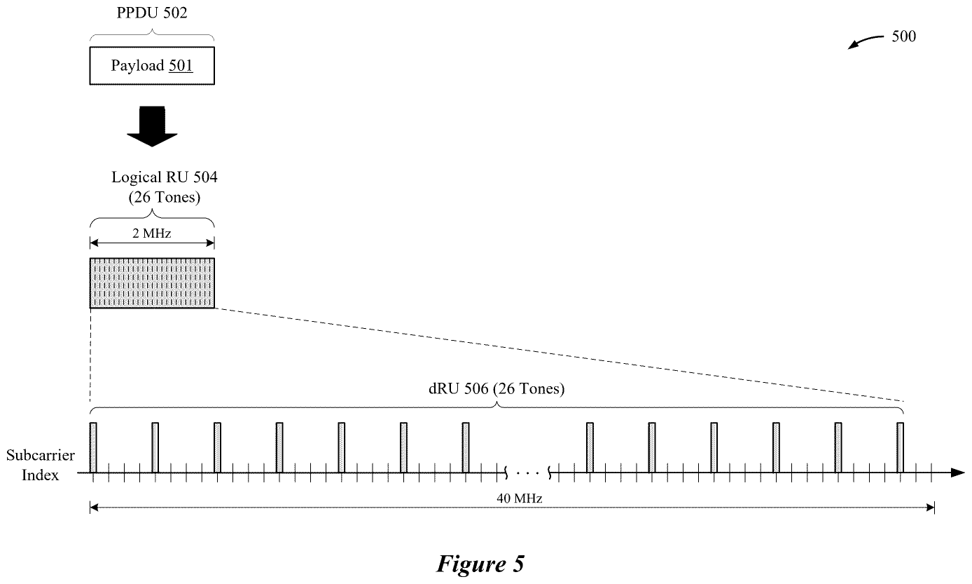

FIG. 5 shows a frequency diagram 500 depicting an example distributed tone mapping. More specifically, FIG. 5 shows an example mapping of how the tones of a payload 501 of a PPDU 502 are distributed for transmission over a spreading bandwidth of a wireless channel. In the illustrated example, the tones in a logical RU 504 (which may represent a remote RU (rRU) of non-distributed tones in accordance with a legacy tone plan) associated with payload 501 are mapped to a distributed RU (dRU) 506 in accordance with a distributed tone plan.

Aspects of the present disclosure recognize that by distributing the tones across a wider bandwidth, the per-tone transmit power of a logical RU 504 may be increased to provide greater flexibility in medium utilization for power spectral density (PSD)-limited wireless channels. For example, when mapped to an rRU such as logical RU 504, the transmit power of the logical RU 504 may be severely limited based on the PSD of the wireless channel. For example, a low power indoor (LPI) power class limits the transmit power of APs 102 and STAs 104 to 5 dBm/MHz and −1 dBm/MHz, respectively, in the 6 GHz band. As such, the per-tone transmit power of the logical RU 504 is limited by the number of tones mapped to each 1 MHz subchannel of the wireless channel.

By enabling a STA 104 to map modulation symbols in a distributed manner onto noncontiguous tones interspersed throughout all or a portion of a wireless channel, distributed transmissions may enable an increase in the per-tone transmit power used for each individual distributed tone, and thus the overall transmit power of the PPDU 502, without exceeding the PSD limits of the wireless channel. As shown in the example of FIG. 5, the STA 104 may map logical RU 504 to a set of 26 noncontiguous subcarrier indices spread across a 40 MHz wireless channel (also referred to herein as a “spreading bandwidth”). Compared to the tone mapping described above with respect to the legacy tone plan, the distributed tone mapping depicted in FIG. 5 effectively reduces the number of tones (of the logical RU 504) in each 1 MHz subchannel. For example, each of the 26 tones can be mapped to a different 1 MHz subchannel of the 40 MHz channel. As a result, each AP 102 or STA 104 implementing the distributed tone mapping of FIG. 5 can maximize its per-tone transmit power (which may maximize the overall transmit power of the logical RU 504).

In some examples (not shown in FIG. 5), multiple logical RUs may be mapped to interleaved subcarrier indices of a shared wireless channel. For example, a STA 104 may modulate a portion of the symbols on a number of tones representing multiple logical RUs to noncontiguous subcarrier indices associated with a shared wireless channel in accordance with a distributed tone plan. Furthermore, distributed transmissions by multiple STAs 104 may be multiplexed onto different sets of distributed tones of a shared wireless channel such as to enable an increase in the transmit power of each device without sacrificing spectral efficiency. Such increases in transmit power can be combined with some MCSs to increase the range and throughput of wireless communications on PSD-limited wireless channels. Distributed transmissions also may improve packet detection and channel estimation capabilities.

To support distributed transmissions, new packet designs and signaling may be used to indicate whether a PPDU 502 is transmitted on tones spanning an rRU, such as a logical RU 504 (according to a legacy tone plan), or a dRU 506 (according to a distributed tone plan). For example, the IEEE 802.11be standard amendment or earlier versions of the IEEE 802.11 family of wireless communication protocol standards define a trigger frame format which can be used to solicit the transmission of a trigger-based (TB) PPDU from one or more STAs 104. The trigger frame allocates resources to the STAs 104 for the transmission of the TB PPDU and indicates how the TB PPDU is to be configured for transmission. For example, the trigger frame may indicate a logical RU or multiple RU (MRU) allocated for transmission in the TB PDDU. In some examples, the trigger frame may be further configured to carry tone distribution information indicating whether the logical RU (or MRU) maps to an rRU or a dRU.

In some implementations, a STA 104 may include a distributed tone mapper that maps the logical RU 504 to the dRU 506 in the frequency domain. The dRU 506 is converted to a time-domain signal (such as by an inverse fast Fourier transform (IFFT)) for transmission over a wireless channel. The AP 102 may receive the time-domain signal and reconstruct the dRU 506 (such as by a fast Fourier transform (FFT)). In some implementations, the AP 102 may include a distributed tone demapper that demaps the dRU 506 to the logical RU 504. In other words, the distributed tone demapper reverses the mapping performed by the distributed tone mapper at the STA 104. The AP 102 can recover the information carried (or modulated) on the logical RU 504 as a result of the demapping.

In the example of FIG. 5, the logical RU 504 is distributed evenly across the spreading bandwidth. While the example shown in FIG. 5 illustrates a spreading bandwidth of 40 MHz, spreading bandwidths also may include 80 MHz, 160 MHz, or 320 MHz. In some implementations, the logical RU 504 can be mapped to any suitable pattern of noncontiguous subcarrier indices. For example, in various implementations, the distance between any pair of adjacent modulated tones may be less than or greater than the distances depicted in FIG. 5.

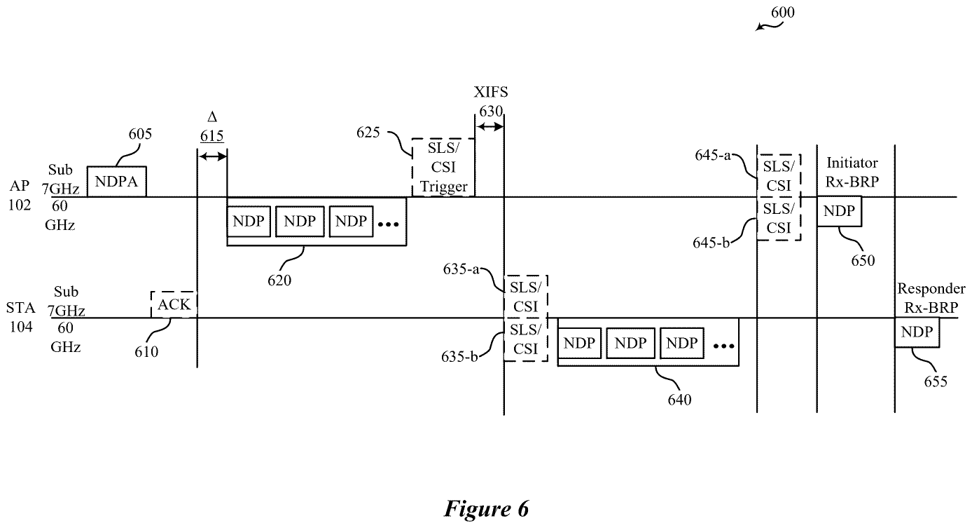

FIG. 6 shows an example of a beam search procedure 600 that supports 60 GHz NDP sounding. An AP 102 and a wireless STA 104 may perform at least part of a sounding sequence for a wireless channel associated with a 60 GHz communication band. The beam search procedure 600 may show an example of a sub-7 GHz assisted beam search. For example, the AP 102 and the STA 104 may communicate via a 60 GHz wireless channel (for example, for data transmission) and a sub-7 GHz wireless channel (for example, for control information signaling).

The AP 102 may transmit an NDPA frame 605 to the STA 104 via the sub-7 GHz wireless channel. The NDPA frame 605 may indicate information for the beam search procedure. In some examples, the NDPA frame may indicate a beam search type. For example, the NDPA frame 605 may indicate whether the beam search procedure 600 is a full beam search, a transmitter-only beam search, a receiver-only beam search, a beam search of a subset of spatial sectors, or any combination thereof. In some examples, the NDPA frame 605 may indicate a training method for the beam search procedure 600. For example, the NDPA frame 605 may indicate whether a beam search procedure is a 1D beam search or a 2D beam search. The beam search procedure 600 illustrated by FIG. 6 may be an example of a 1D beam search procedure. In some examples, the NDPA frame 605 may indicate a training length. In some examples, the NDPA frame 605 may indicate a first transmit sector identifier, a last transmit sector identifier, a first transmit antenna identifier, a last transmit antenna identifier, or any combination thereof, for the beam search procedure 600. In some examples, the NDPA frame 605 may indicate a receiver-SLS length or a quantity of receive antennas (for example, of the STA 104) for the beam search procedure 600. In some examples, the NDPA frame 605 may indicate a quantity of streams (for example, spatial streams) for the beam search procedure 600. In some examples, the beam search type may be indicated via three bits, the training method may be indicated by one bit, the training length may be indicated by five bits, the first transmit second identifier may be indicated by six bits, the last transmit sector identifier may be indicated by six bits, the first transmit antenna identifier may be indicated by two bits, the last transmit antenna identifier may be indicated by two bits, the receiver-SLS length or quantity of receiver antennas may be indicated by six bits, and a quantity of spatial streams may be indicated by two bits. In some examples, the AP 102 may transmit the NDPA frame 605 to setup beam training parameters and provide a timing and frequency reference for the 60 GHz communication link (over the 60 GHz wireless channel).

In some examples, the STA 104 may transmit an acknowledgement 610 in response to the NDPA frame 605. For example, the STA 104 may transmit the acknowledgement 610 via the sub-7 GHz channel in response to the NDPA frame 605. In some examples, the AP 102 may transmit a first set of NDP frames 620 after a delay 615 from the acknowledgement 610 or the NDPA frame 605. In some examples, the delay 615 may be scheduled. For example, the NDPA frame 605 may indicate a duration of the delay. Additionally, or alternatively, a duration of the delay 615 may be pre-configured or statically configured.

The AP 102 may transmit a first set of NDP frames 620. In some examples, the AP 102 may transmit an NDP frame using each transmit beam of the AP 102. In some examples, the AP 102 may transmit an NDP frame using a subset of transmit beams of the AP 102, including transmit beams directed at the STA 104 or in transmit sectors directed to the STA 104. In some examples, the AP 102 may transmit an NDP frame in accordance with transmit beam information indicated by the NDPA frame 605. In some examples, transmission of the first set of NDP frames 620 by the AP 102 may be an example of an initiator's SLS.

The STA 104 may receive the first set of NDP frames 620 and measure the first set of NDP frames 620. In some examples, the STA 104 may use a quasi-omnidirectional receive beam to receive the first set of NDP frames 620. In some examples, the STA 104 may determine an NDP frame of the first set of NDP frames 620 with a highest measurement, such as a highest receive power measurement. In some examples, the STA 104 may determine at least a portion of a channel measurement for the 60 GHz wireless channel based on measuring the first set of NDP frames 620.

In some examples, the AP 102 may transmit a feedback trigger 625 via the sub-7 GHz channel. In some examples, the AP 102 may check whether the sub-7 GHz channel is available before transmission of the feedback trigger 625. In some examples, the feedback trigger 625 may trigger the STA 104 to transmit SLS information or CSI, or both. In some examples, the AP 102 may transmit the feedback trigger 625 based on the sounding procedure being a trigger-based sounding sequence or a trigger-based sounding procedure.

In some examples, the STA 104 may transmit SLS information or CSI information, or both, shown as an SLS/CSI 635 in FIG. 6. The SLS/CSI 635 may be an example of an SLS/CSI report. In some examples, the STA 104 may transmit the SLS/CSI 635 after a delay 630, such as an extended interframe spacing (XIFS), from the feedback trigger 625. In some examples, such as for a single-input, single-output (SISO) beam selection procedure, SLS/CSI may indicate a best antenna identifier, a best sector identifier, an SNR report, or any combination thereof. In some examples, such as for a MIMO beam selection procedure, the SLS/CSI may include an identifier of a best radiofrequency chain for each spatial stream. In some examples, the SLS/CSI for a MIMO beam selection procedure may indicate a best antenna identifier for each spatial stream, a best sector identifier for each spatial stream, and an SNR report for each spatial stream. In some examples, the SLS/CSI 635 may indicate a best beam of the AP 102 based on measurements of the first set of NDP frames 620. In some examples, the STA 104 may transmit the SLS/CSI 635 in response to the feedback trigger 625. The STA 104 may transmit the SLS/CSI 635 via the 60 GHz wireless channel (an SLS/CSI 635-b) or via the sub-7 GHz wireless channel (an SLS/CSI 635-a). In some cases, the STA 104 may transmit the SLS/CSI 635 if NDP frames, such as a second set of NDP frames 640, transmitted by the STA 104 for the sounding sequence do not include the SLS/CSI feedback information.

The STA 104 may transmit a second set of NDP frames 640. In some examples, the STA 104 may transmit an NDP frame using each beam of a set of beams of the STA 104. In some examples, the STA 104 may transmit an NDP frame using a subset of beams of the STA 104, such as a subset of beams identified by the NDPA frame 605, beam which are directed toward the AP 102, or beams which are in a sector in the direction of the AP 102, or any combination thereof.

The AP 102 may receive the second set of NDP frames 640 and measure the second set of NDP frames 640. In some examples, the AP 102 may use a quasi-omni directional receive beam to receive the second set of NDP frames 640. In some examples, the AP 102 may determine an NDP frame of the second set of NDP frames 640 with a highest measurement, such as a highest received power measurement. In some examples, the AP 102 may determine at least a portion of a channel measurement for the 60 GHz wireless channel based on measuring the second set of NDP frames 640. In some examples, transmission of the second set of NDP frames 640 by the STA 104 may be an example of a responder's transmitter SLS.

In some examples, the AP 102 may transmit SLS information or CSI information, or both, shown as an SLS/CSI 645 in FIG. 6. The AP 102 may transmit the SLS/CSI 645 via the 60 GHz wireless channel (an SLS/CSI 645-b) or via the sub-7 GHz wireless channel (an SLS/CSI 645-a). In some cases, the AP 102 may transmit the SLS/CSI 645 if a following NDP frame, such as an NDP frame 650, does not include the SLS/CSI feedback information. In some examples, the SPS/CSI 645 may indicate a best beam of the STA 104 based on measurements of the second set of NDP frames 640.

In some examples, the AP 102 may transmit an NDP frame 650 for a receiver-side beam refinement procedure (BRP). The AP 102 and the STA 104 may perform the BRP based on the sounding sequence using a 1D beam search or 1D scanning. In some examples, the AP 102 may transmit the NDP frame 650 using a beam identified by the SLS/CSI 635. The STA 104 may transmit an NDP frame 655 as part of the receiver-side BRP. The STA 104 may transmit the NDP using a beam identified by the SLS/CSI 645. In some examples, the AP 102 may transmit the NDP frame 650 via the 60 GHz channel, and the STA 104 may transmit the NDP frame 655 via the 60 GHz channel.

In some examples, a sub-7 GHz-assisted beam search procedure, such as the beam search procedure 600, may be a part of a whole sounding sequence. For example, the sub-7 GHz-assisted beam search procedure may performed as a full beam search or as a partial beam search for an initial beam search or beam recovery. In some examples, the sub-7 GHz-assisted beam search procedure may be part of a sounding sequence based on whether there is transmitter-receiver radiofrequency reciprocity.

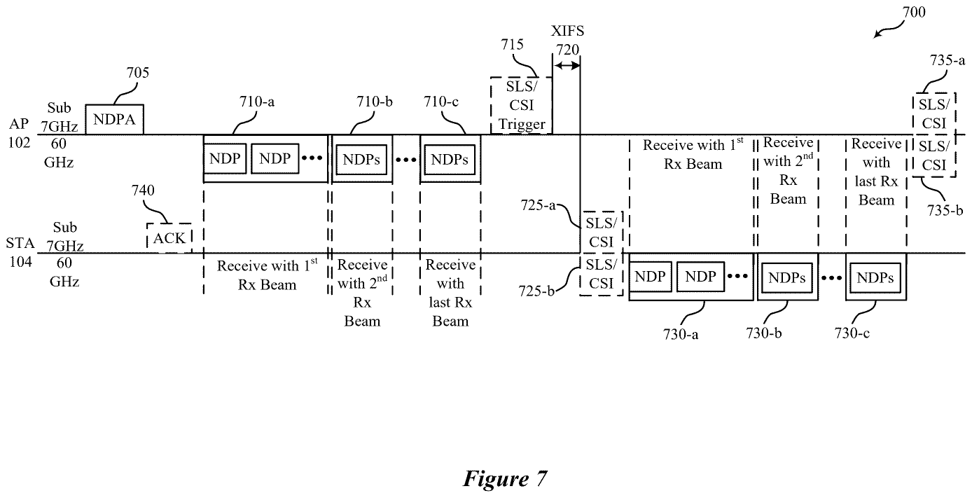

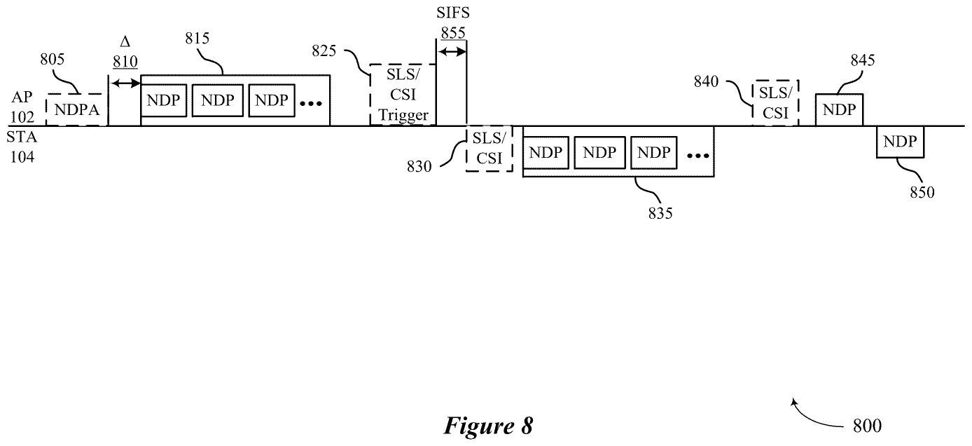

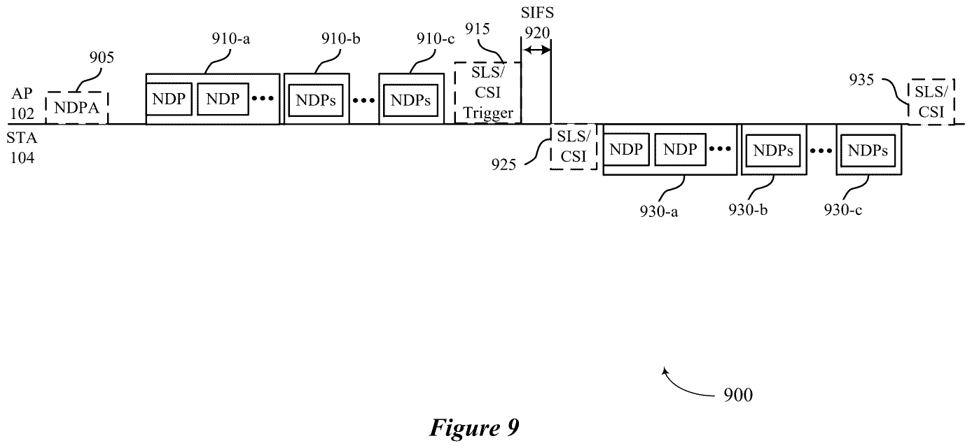

In some examples, an NDP frame may have an NDP frame format that is based on a control PHY (CPHY) PPDU. For example, an NDP frame may have an NDP frame format based on a degraded CPHY PPDU format (e.g., a short NDP that omits one or more fields of a legacy NDP frame format). In some examples, the degraded CPHY PPDU format may include one or more LTF fields or one or more short training sequences for signal measurement, but may otherwise omit other fields of the NDP frame (e.g., a short NDP that only includes an LTF field, a short training sequence, or both, but otherwise omits one or more fields of a legacy NDP frame format). In some examples, the degraded CPHY PPDU format may include one or more LTF fields and one or more SIG fields, such as if the degraded CPHY PPDU format is used for a short beam message or report. A degraded CPHY format may be used for a 1D beam scan, as described with reference to FIGS. 6 and 8, or a 2D beam scan, as described with reference to FIGS. 7 and 9. The degraded CPHY format may utilize PHY coupling between sub-7 GHz and 60 GHz. For example, a sub-7 GHz link (for example, over the sub-7 GHz wireless channel) and a higher-frequency link, such as a 45 GHz link or a 60 GHz link over the 60 GHz wireless channel, may share a same local oscillator, and the sub-7 GHz link may provide a timing and frequency reference for the higher-frequency link. In some examples, a degraded CPHY PPDU format may consist of one training sequence only (for example one LTF) with a duration of 1 microsecond in an SLS stage. In some examples, a degraded CPHY PPDU format may have a duration of 1 microsecond plus an additional 1 microsecond per TRN subfield for each receive antenna element in a receiver-side BRP process. If the degraded CPHY PPDU format is used to do a beam search procedure for multiple streams, an NDP frame having the degraded CPHY PPDU format may include multiple LTFs for each beam training (e.g., but may otherwise omit other fields of a legacy NDP frame format), where the quantity of LTFs is greater than or equal to a quantity of spatial streams.

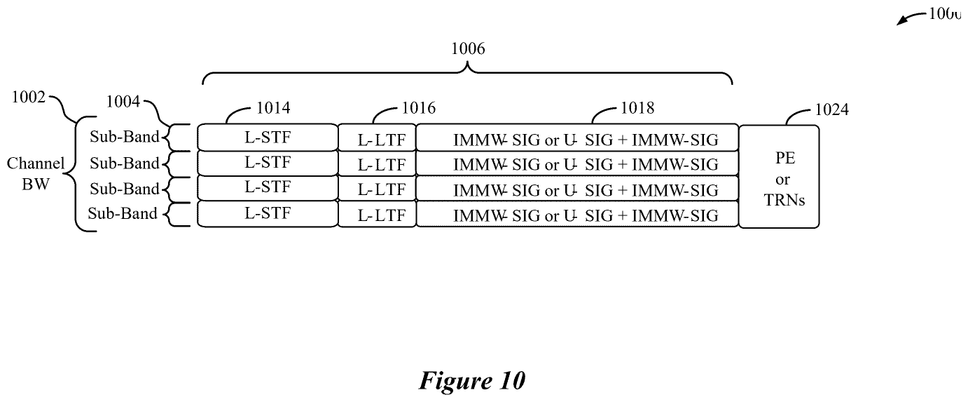

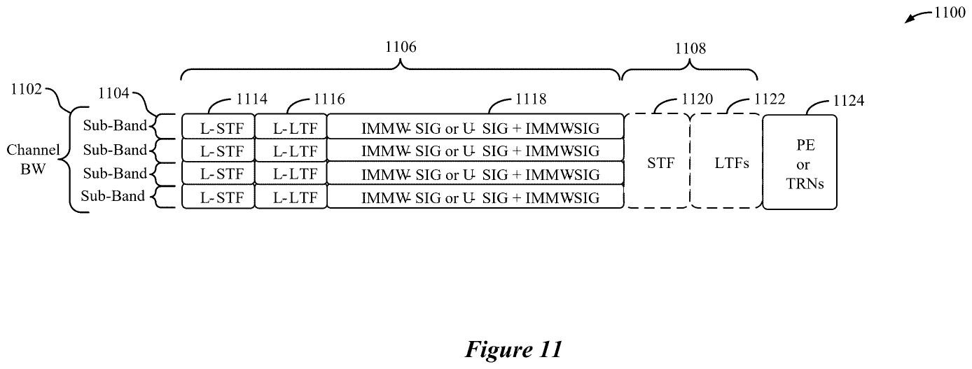

In some examples, different NDP frames may have different NDP frame formats. For example, an NDP frame of the first set of NDP frames 620 may have a first NDP frame format, and the NDP frame 650 may have a second NDP frame format that is different from the first NDP frame format. For example, one NDP frame in a beam search procedure may have an NDP frame format (or PPDU frame format) as described with reference to FIG. 10, and another NDP frame used in the same beam search procedure may have an NDP frame format (or PPDU frame format) as described with reference to FIG. 11.

In some examples, a transmitting device, such as the AP 102 or the STA 104, may transmit an NDP frame via an NDP bandwidth of the 60 GHz wireless channel. The NDP bandwidth may be 320 MHz, 640 MHz, 1280 MHz, or 160 MHz. In some examples, the transmitting device may transmit the NDP frame over an entire data PPDU bandwidth. For example, the NDP frame may populate all valid tones defined for a given PPDU bandwidth mode. In some examples, the transmitting device may transmit the NDP frame over a subband or base frequency block of any allowed IMMW PPDU bandwidth mode. The base frequency block may be a smallest data PPDU bandwidth or 64 tones, such that the NDP bandwidth may be smaller than a smallest data PPDU bandwidth. In some examples, the transmitting device may transmit the NDP frame over subband to gain some power boost, such as if there are no PSD limitations. In some examples, the transmitting device may transmit the NDP frame over an entire data PPDU bandwidth, with the NDP frame populating on distributed or sparse tones of the entire data PPDU bandwidth. In some examples, the NDP frame obtains power boost by transmitting on distributed tones to address any link budget issues, and measurement of beams may occur over an entire bandwidth to mitigate any possible beam squint effect.

FIG. 7 shows an example of a beam search procedure 700 that supports 60 GHz NDP sounding. An AP 102 and a wireless STA 104 may perform at least part of a sounding sequence for a wireless channel associated with a 60 GHz communication band. The beam search procedure 700 may show an example of a sub-7 GHz assisted beam search. For example, the AP 102 and the STA 104 may communicate via a 60 GHz wireless channel (for example, for data signaling) and a sub-7 GHz wireless channel (for example, for control information signaling).

The AP 102 may transmit an NDPA frame 705 to the STA 104 via the sub-7 GHz wireless channel. The NDPA frame 705 may be an example of an NDPA frame 605 described with reference to FIG. 6. The NDPA frame 705 may indicate information for the beam search procedure. In some examples, the STA 104 may transmit an acknowledgement 740 in response to the NDPA frame 705. In some examples, the AP 102 may transmit multiple sets of NDP frames 710 after a delay from the acknowledgement. In some examples, the delay may be scheduled. In some examples, the AP 102 may check whether the sub-7 GHz channel is available after transmission of the NDPA frame 705 for triggering feedback from the sub-7 GHz channel.

In some examples, the AP 102 and the STA 104 may communicate a request and a response, and transmission of the NDPA frame 705 may be based on the request and/or the response. A first device may communicate a request, such as a beam training request, and a second device may communicate a response, such as a beam training response. For example, the AP 102 may transmit the NDPA frame 705 based on or in accordance with the response. In some examples, the AP 102 may transmit the request, and the STA 104 may transmit the response. In some other examples, the STA 104 may transmit the request, and the AP 102 may transmit the response. The AP 102 may transmit (e.g., output) a beam training request via a second wireless channel of the sub-7 GHz communication band and receive (e.g., obtain) a beam training response via the second wireless channel of the sub-7 GHz communication band responsive to the beam training request. For example, instead of first communicating the NDPA frame 705 and then communicating the acknowledgement 740, the AP 102 and the STA 104 may communicate a request and a response, then the AP 102 may transmit the NDPA frame 705.

The beam search procedure 700 may be an example of a beam search procedure or a sounding sequence which uses 2D scanning. The AP 102 may transmit multiple sets of NDP frames 710. In some examples, the AP 102 may transmit each NDP frame of a set of NDP frames 710 using a different transmit beam of the AP 102. In some examples, the AP 102 may transmit the NDP frames in a set of NDP frames 710 using a subset of transmit beams of the AP 102, including transmit beams directed at the STA 104 or in transmit sectors directed to the STA 104. In some examples, the AP 102 may transmit the multiple sets of NDP frames 710 for downlink beam training. In some examples, the AP 102 may transmit NDP frames in a set of NDP frames 710 in accordance with transmit beam information indicated by the NDPA frame 705. In some examples, transmission of the multiple sets of NDP frames 710 by the AP 102 may be an example of an initiator's SLS.

In some examples, a 2D scanning may include a receiver-side SLS or a receiver-side BRP, or both, within a same transmit beam direction, performing the scanning over all sectors of the transmitter. For the receiver-side SLS, each NDP packet (for example, each NDP frame 710) may be received using a different receive beam direction. By receiving the repeated NDP packets, the receiver may scan overall of its beams. For the receiver-side BRP, in some examples one NDP packet may be transmitted. The NDP packet may include a training field with multiple training symbols. An LTF symbol may be an example of the training symbols included in the training field. Each training symbol or sub-group of training symbols may be received with a different receive beam direction. In some examples, the different beam directions may correspond to different antenna weight vectors.

The AP 102 may transmit a set of NDP frames 710 once for each receive beam of the STA 104. For example, the STA 104 may receive a first set of NDP frames 710-a using a first receive beam, a second set of NDP frames 710-b using a second receive beam, and an Nth set of NDP frames 710-c using an Nth receive beam (for example, a last receive beam). For example, after the set of NDP frames 710-c, the STA 104 may have measured an NDP frame transmitted using each transmit beam of the AP 102 with each receive beam of the STA 104. In some examples, the STA 104 may determine an NDP frame of the multiple sets of NDP frames 710 with a highest measurement, such as a highest received power measurement. For example, the STA 104 may determine a beam pair (including a transmit beam of the AP 102 and a receive beam of the STA 104) which has a highest received power measurement. In some examples, the STA 104 may determine at least a portion of a channel measurement for the 60 GHz wireless channel based on measuring the sets of NDP frames 710.

In some examples, the AP 102 may transmit a feedback trigger 715. In some examples, the feedback trigger 715 may trigger the STA 104 to transmit SLS information or CSI, or both. In some examples, the AP 102 may check whether the sub-7 GHz channel is available before triggering feedback from the sub-7 GHz channel. In some examples, the AP 102 may transmit the feedback trigger 715 based on the sounding procedure being a trigger-based sounding sequence or a trigger-based sounding procedure. In some examples, the STA 104 may transmit SLS information or CSI information, or both, shown as an SLS/CSI 725 in FIG. 7. The SLS/CSI 725 may be an example of SLS/CSI described with reference to FIG. 6. In some examples, the SLS/CSI 725 may indicate a best transmit beam of the AP 102, a best receive beam of the STA 104, or both, based on measurements of the sets of NDP frames 710. In some examples, the STA 104 may transmit the SLS/CSI 725 in response to the feedback trigger 715. In some examples, the STA 104 may transmit the SLS/CSI 725 after a delay 720, such as an XIFS or a SIFS. The STA 104 may transmit the SLS/CSI 725 via the 60 GHz wireless channel (an SLS/CSI 725-b) or via the sub-7 GHz wireless channel (an SLS/CSI 725-a). In some cases, the STA 104 may transmit the SLS/CSI 725 if NDP frames, such as NDP frames in sets of NDP frames 730, transmitted by the STA 104 for the sounding sequence do not include the SLS/CSI feedback information.

The STA 104 may transmit multiple sets of NDP frames 730. In some examples, the STA 104 may transmit an NDP frame of a set of NDP frames 730 using each beam of a set of beams of the STA 104. For example, the STA 104 may transmit each NDP frame in a first set of NDP frames 730-a using a different transmit beam. In some examples, the STA 104 may transmit the NDP frames in a set of NDP frames 730 using a subset of beams of the STA 104, such as a subset of beams identified by the NDPA frame 705, beam which are directed toward the AP 102, or beams which are in a sector in the direction of the AP 102, or any combination thereof.

The AP 102 may receive the sets of NDP frames 730 and measure the sets of NDP frames 730. The AP 102 may receive each set of NDP frames 730 using a different receive beam. For example, the AP 102 may receive the first set of NDP frames 730-a using a first receive beam, a second set of NDP frames 730-b using a second receive beam, and an Mth set of NDP frames 730-c using an Mth receive beam. In some examples, the AP 102 may determine an NDP frame of the sets of NDP frames 730 with a highest measurement, such as a highest power measurement. For example, the AP 102 may determine a best beam pair when the STA 104 is transmitting and the AP 102 is receiving based on measuring the sets of NDP frames 730. In some examples, the AP 102 may determine at least a portion of a channel measurement for the 60 GHz wireless channel based on measuring the sets of NDP frames 730.

In some examples, the AP 102 may transmit SLS information or CSI information, or both, shown as an SLS/CSI 735 in FIG. 7. The SLS/CSI 735 may be an example of SLS/CSI described with reference to FIG. 6. The AP 102 may transmit the SLS/CSI 735 via the 60 GHz wireless channel (an SLS/CSI 735-b) or via the sub-7 GHz wireless channel (an SLS/CSI 735-a).

Transmission of the sets of NDP frames 710 or the sets of NDP frames 730 may be referred to as an SLS procedure. For example, the AP 102 transmitting the first set of NDP frames 710-a and the STA 104 receiving the first set of NDP frames 710-a may be an example of a first round of transmitter SLS, where the AP 102 is the transmitter and the STA 104 is the receiver. In some examples, the receiver may transmit SLS/CSI (SLS/CSI 725 if the STA 104 is the receiver or SLS/CSI 735 if the AP 102 is the receiver) after every round of transmitter SLS. For example, the STA 104 may transmit an SLS/CSI 725 after a first set of NDP frames 710-a or after a second set of NDP frames 710-b. Transmitting SLS/CSI after every round of SLS may enable early termination of beam training, such as if the receiver detects a beam pair which satisfies one or more thresholds.

In some examples, a sub-7 GHz-assisted beam search procedure, such as the beam search procedure 700, may be a part of a whole sounding sequence. For example, the sub-7 GHz-assisted beam search procedure may performed as a full beam search or as a partial beam search for an initial beam search or beam recovery. In some examples, the sub-7 GHz-assisted beam search procedure may be part of a sounding sequence based on whether there is transmitter-receiver radiofrequency reciprocity.

FIG. 8 shows an example of a beam search procedure 800 that supports 60 GHz NDP sounding. An AP 102 and a wireless STA 104 may perform at least part of a sounding sequence for a wireless channel associated with a 60 GHz communication band. The beam search procedure 800 may show an example of a 1D beam search procedure which is not assisted by a sub-7 GHz wireless channel.

In some examples, the AP 102 may transmit an NDPA frame 805 to the STA 104 via the 60 GHz wireless channel. The NDPA frame 805 may be an example of an NDPA frame 605 described with reference to FIG. 6. The NDPA frame 805 may indicate information for the beam search procedure. In some examples, the AP 102 may transmit a set of NDP frames 815 after a delay 810 from the NDPA frame 805. In some examples, the delay 810 may correspond to a short interframe spacing (SIFS).

In some examples, an NDP frame of the set of NDP frames 815 may include aspects of a CPHY PPDU. For example, an NDP frame may include aspects of a PPDU format 1000 described with reference to FIG. 10. In some examples, the NDPA frame 805 may formatted according to the CPHY PPDU format. A CPHY PPDU may include a long L-STF, a preamble (for example, including a SIG field) with frequency domain duplication and time domain duplication to boost link budget SNR. A CPHY PPDU may include an IMMW-SIG field and a U-SIG field or may be combined or jointly encoded into an IMMW-SIG field. In some examples, the U-SIG and IMMW-SIG fields may be repeated in the time domain. A CPHY PPDU may include one or more training fields or one or more packet extension fields, or both.

The AP 102 may transmit the set of NDP frames 815 according to a 1D beam scanning procedure described herein. For example, the AP 102 may transmit each NDP frame of the set of NDP frames 815 using a different transmit beam. The STA 104 may receive the set of NDP frames 815 using a quasi-omni directional receive beam. In some examples, the AP 102 may transmit a feedback trigger 825 (SLS/CSI trigger). In some examples, the feedback trigger 825 may be transmitted using the CPHY format. After a delay 855, such as an SIFS, the receiver (for example, the STA 104) may transmit SLS information and/or CSI (SLS/CSI 830) to the AP 102 based on measurements of the set of NDP frames 815.

The STA 104 may transmit a set of NDP frames 835 according to the 1D beam scanning procedure. For example, the STA 104 may transmit each NDP frame of the set of NDP frames 835 using a different transmit beam. The AP 102 may receive and measure the set of NDP frames 835 using a quasi-omni directional receive beam. In some examples, the AP 102 may transmit SLS/CSI 840 indicating measurement information for the set of NDP frames 835. The SLS/CSI 840 may be an example of SLS/CSI described with reference to FIG. 6.

In some examples, the AP 102 may transmit an NDP frame 845 for a BRP. In some examples, the AP 102 and the STA 104 may perform the receiver-side BRP based on the sounding sequence using a 1D beam search or 1D scanning. In some examples, the AP 102 may transmit the NDP frame 845 using a transmit beam identified by the SLS/CSI 830. The STA 104 may transmit an NDP frame 850 as part of the BRP. The STA 104 may transmit the NDP using a beam identified by the SLS/CSI 840. The NDP frame 845 and the NDP frame 850 may be transmitted via the 60 GHz wireless channel.

In some examples, the beam search procedure 800 may not use the CPHY PPDU format. For example, the beam search procedure 800 may be an example of a beam search procedure which is not sub-7 GHz-assisted and without CPHY. For example, the AP 102 may not transmit an NDPA frame 805, and the AP 102 may transmit the set of NDP frames 815 directly (for example, without the NDPA frame 805). Sounding parameters, indicated by the NDPA frame 805 in some other examples, may be indicated by a SIG field of the NDP frames in the set of NDP frames 815 or preconfigured at the AP 102 or STA 104. In some examples, the AP 102 may not transmit the feedback trigger 825 if the NDPA frame 805 is not transmitted. In some examples, the STA 104 may transmit the SLS/CSI 830 after a SIFs from the set of NDP frames 815. In some examples, a non-sub-7 GHz assisted beam search procedure without CPHY may be performed when doing beam recovery, for example after a broken communication link is detected by the AP 102 or the STA 104, or both.

In some examples, without using a CPHY PPDU format, the NDPA frame 805 or the feedback trigger 825, or both, may be transmitted with a data PHY (DPHY) PPDU format. For example, the NDPA frame 805 or the feedback trigger 825, or both, may include a preamble of a DPHY PPDU format (e.g., only include the preamble). The preamble may be duplicated across the frequency domain (for example, to span a 320 MHz bandwidth). In some examples, an L-STF of the preamble may be extended for 1D beam scanning. Additionally, or alternatively, the NDPA frame 805 or the feedback trigger 825, or both, may be transmitted using an ELR DPHY PPDU format or an ELR PPDU format. The ELR PPDU format may include a PPDU format 1000 described with reference to FIG. 10 with power boosting and signal repetition. In some examples, the ELR PPDU format may be used for beam recovery or a BRP.

FIG. 9 shows an example of a beam search procedure 900 that supports 60 GHz NDP sounding. An AP 102 and a wireless STA 104 may perform at least part of a sounding sequence for a wireless channel associated with a 60 GHz communication band. The beam search procedure 900 may show an example of a 2D beam search procedure which is not assisted by a sub-7 GHz wireless channel.

In some examples, the AP 102 may transmit an NDPA frame 905 to the STA 104 via the 60 GHz wireless channel. The NDPA frame 905 may be an example of an NDPA frame 605 described with reference to FIG. 6. The NDPA frame 905 may indicate information for the beam search procedure. In some examples, the AP 102 may transmit sets of NDP frames 910 after a delay from the NDPA frame 805. In some examples, the delay may correspond to a SIFS.

The AP 102 may transmit the sets of NDP frames 910 according to a 2D beam scanning procedure described herein. For example, the AP 102 may transmit each NDP frame of a set of NDP frames 910 using a different transmit beam. The STA 104 may receive each set of NDP frames 910 using a different receive beam. For example, the STA 104 may receive a first set of NDP frames 910-a using a first receive beam, a second set of NDP frames 910-b using a second receive beam, and an Nth set of NDP frames 910-c using an Nth receive beam. In some examples, the AP 102 may transmit a feedback trigger 915 (SLS/CSI trigger). In some examples, the NDPA frames, the feedback trigger 915, or both, may be transmitted using the CPHY format. After a delay 920, such as a SIFS, the receiver 104 may transmit SLS information and/or CSI (SLS/CSI 925) to the AP 102 based on measurements of the sets of NDP frames 910. The SLS/CSI 925 may be an example of SLS information or CSI described herein. In some examples, an NDP frame of the set of NDP frames 910, the NDPA frame 905, the feedback trigger 915, or any combination thereof, may include aspects of a CPHY PPDU described herein.

The STA 104 may transmit sets of NDP frames 930 according to the 2D beam scanning procedure. For example, the STA 104 may transmit each NDP frame of a set of NDP frames 930 using a different transmit beam. The AP 102 may receive and measure each set of NDP frames 910 using a different receive beam. For example, the AP 102 may receive a first set of NDP frames 930-a using a first receive beam, a second set of NDP frames 930-b using a second receive beam, and an Mth set of NDP frames 930-c using an Mth receive beam. In some examples, the AP 102 may transmit SLS/CSI 935 indicating measurement information for the sets of NDP frames 930. The SLS/CSI 935 may be an example of SLS/CSI described herein.

Additionally, or alternatively, the NDPA frame 905 or the feedback trigger 915, or both, may be transmitted using an ELR DPHY PPDU format or an ELR PPDU format. The ELR PPDU format may include a PPDU format 1000 described with reference to FIG. 10 with power boosting and signal repetition. In some examples, the ELR PPDU format may be used for beam recovery or a BRP.

In some examples, the beam search procedure 900 may not use the CPHY PPDU format. For example, the beam search procedure 900 may be an example of a beam search procedure which is not sub-7 GHz-assisted and without CPHY. For example, the AP 102 may not transmit an NDPA frame 905, and the AP 102 may transmit the sets of NDP frames 910 directly (for example, without the NDPA frame 905). Sounding parameters, indicated by the NDPA frame 905 in some other examples, may be indicated by a SIG field of the NDP frames in the sets of NDP frames 910 or preconfigured at the AP 102 or STA 104. In some examples, the AP 102 may not transmit the feedback trigger 915 if the NDPA frame 905 is not transmitted. In some examples, the STA 104 may transmit the SLS/CSI 925 after a SIFs from a last set of NDP frames (for example, the set of NDP frames 910-c). In some examples, a non-sub-7 GHz beam search procedure without CPHY may be performed when doing beam recovery, for example after a broken communication link is detected by the AP 102 or the STA 104, or both.

In some examples, a 2D scanning may include a receiver-side SLS or a receiver-side BRP, or both, within a same transmit beam direction, performing the scanning over all sectors of the transmitter. For the receiver-side SLS, each NDP packet (for example, each NDP frame 910) may be received using a different receive beam direction. By receiving the repeated NDP packets, the receiver may scan overall of its beams. For the receiver-side BRP, in some examples one NDP packet may be transmitted. The NDP packet may include a training field with multiple training symbols. An LTF symbol may be an example of the training symbols included in the training field. Each training symbol or sub-group of training symbols may be received with a different receive beam direction. In some examples, the different beam directions may correspond to different antenna weight vectors.

FIG. 10 shows an example of a PPDU format 1000 that supports 60 GHz NDP sounding. In some examples, the PPDU format 1000 may be an upclocked frame structure in which an L-SIG field may be jointly encoded with other SIG fields into an IMMW-SIG field or a U-SIG plus an IMMW-SIG field. For example, a PPDU format 1000 of FIG. 10 may have a structure that corresponds to a control PPDU, or a CPHY PPDU, that is upclocked to span, for example, a 320 MHz or a 640 MHz channel bandwidth associated with 60 GHz communications.

In some examples, the PPDU format 1000 of FIG. 10 may have a structure that corresponds to a data PPDU of IEEE 802.11ac or IEEE 802.11be that is upclocked to span, for example, a 320 MHz or a 640 MHz channel bandwidth associated with 60 GHz communications. The PPDU format 1000 may be an example of an aligned or harmonized data PPDU and control PPDU based on an upclocked IEEE 802.11be20 TB PPDU and IEEE 802.11be20 ER SU PPDU.

The PPDU format 1000 shows an example control PPDU usable for an NDPA field, an NDP field, or other communications between a wireless AP and one or more wireless STAs. For example, the AP and STAs may be examples of the AP 102 and the STAs 104 described with reference to FIG. 1. As shown, the PPDU format 1000 may span a channel bandwidth 1002 (for example, a 320 MHz or a 640 MHz channel bandwidth) including multiple subbands 1004. In this example, the PPDU format 1000 includes a long L-STF 1014, an L-LTF 1016, and an IMMW-SIG 1018 (or a U-SIG+IMMW-SIG) field, and one or more PE or TRN fields 1024. A preamble 1006 may include the long L-STF 1014, the L-LTF 1016, and the IMMW-SIG 1018 (or a U-SIG+IMMW-SIG) field. In some examples, the preamble 1006, including the SIG fields, may be duplicated across the frequency domain or time domain, or both, which may increase link budget SNR. In some examples, the IMMW-SIG 1018 (or the U-SIG+IMMW-SIG) field may be repeated across the time domain. In some examples, the IMMW-SIG 1018 (or the U-SIG+IMMW-SIG) field may be BPSK modulated or QBPSK modulated.

FIG. 11 shows an example of a PPDU format 1100 that supports 60 GHz NDP sounding. In the example of FIG. 11, PPDU format 1100 may be an upclocked frame structure in which an L-SIG field may be jointly encoded with other SIG fields into an IMMW-SIG field or a U-SIG plus an IMMW-SIG field. For example, a PPDU format 1100 of FIG. 11 may have a structure that corresponds to a data PPDU of IEEE 802.11ac, IEEE 802.11be, or IEEE 802.11bq that is upclocked to span, for example, a 320 MHz or a 640 MHz channel bandwidth associated with 60 GHz communications.

The PPDU format 1100 shows an example data PPDU usable for communications between a wireless AP and one or more wireless STAs. For example, the AP and STAs may be examples of the AP 102 and the STAs 104 described with reference to FIG. 1. As shown, the PPDU format 1100 may span a channel bandwidth 1102 (for example, a 320 MHz or a 640 MHz channel bandwidth). In this example, the PPDU format 1100 includes a PHY preamble, that includes a legacy portion 1106 that is duplicated across multiple sub-bands 1104 of the channel bandwidth 1102. The PPDU format may include a payload that includes one or more PE or TRN fields 1124. The legacy portion 1106 of the preamble includes an L-STF 1114, an L-LTF 1116, and the IMMW-SIG 1118 (or a U-SIG+IMMW-SIG) field. The PPDU format 1100 may include a non-legacy portion 1108, for example if a PPDU having the PPDU format 1100 is transmitted using multiple spatial streams. The non-legacy portion 1108 of the preamble may span the channel bandwidth 1102, and may include a STF 1120 (e.g., if a quantity of spatial streams, Nss, is greater than one) and one or more LTFs 1122 (e.g., if a quantity of spatial streams, Nss, is greater than one). In some aspects, SIG symbol(s) may be BPSK modulated or QBPSK modulated.

In some examples, the PPDU format 1100 may be used as an NDP frame during SLS stage of a beam search procedure, such as of the 1D and 2D beam scanning procedures described with reference to FIGS. 6 through 9. A one-segment format until the SIG fields (for example, the U-SIG+IMMW-SIG field) may be used for SISO beam training. A two-segment format with additional STF 1120 and LTF 1122 fields may be used for multi-stream (MIMO) training. In some examples, the PPDU format 1100 may be used for a BRP stage of a beam search procedure, such as of the 1D beam scanning procedures described with reference to FIGS. 6 and 8. In the BRP stage, additional TRN fields 1124 (TRN subfields), such as one for each receive antenna element, may be used for the receiver BRP process. In some examples, additional TRN fields 1124 (TRN subfields) may be used for the transmitter BRP process.

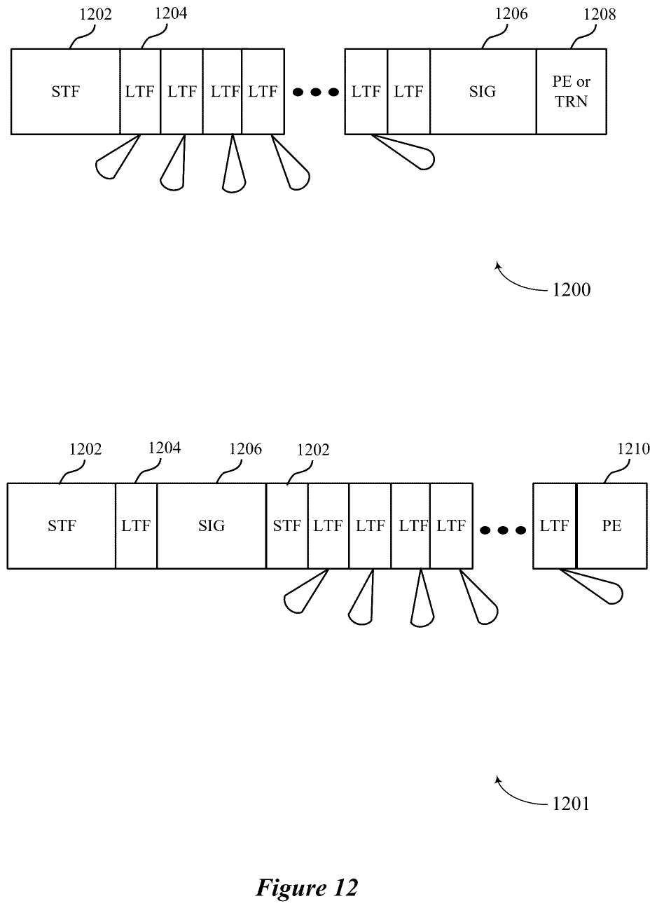

FIG. 12 shows an example of an NDP frame format 1200 and an NDP frame format 1201 that support 60 GHz NDP sounding. In some examples, the NDP frame format 1200 and the NDP frame format 1201 may each be an example of a PPDU frame format.

The NDP frame format 1200 includes an STF 1202 field, multiple LTF 1204 fields, a SIG 1206 field, and one or more packet extension fields or one or more TRN fields 1208, or both. The NDP frame format 1201 includes an STF 1202, multiple LTFs 1204, a SIG 1206, and one or more packet extension fields 1210.

A beam search procedure or beam recovery procedure may include scanning over a set of beam directions to determine which one results in a highest received power. A beam search procedure or beam recovery procedure may be performed by transmitting LTF symbols repeatedly, each with a different beam direction. The repeated LTF symbols may be before or after a SIG 1206 field. The NDP frame format 1200 shows an example of the repeated LTF symbols being before the SIG 1206 field, and the NDP frame format 1201 shows an example of the repeated LTF symbols being after the SIG 1206 field. In some examples, an NDP frame format may include more than one LTF 1204 per beam based on beam switching time. For example, one LTF 1204 may be used for channel measurement after FFT and one LTF may correspond to beam switch padding. In some examples, one LTF 1204 may be twice as long (for example, each LTF symbol has two periods), where one period is used for measurement and the other period is used for beam switching.

In some examples, the NDP frame format 1200 or the NDP frame format 1201 may be used for a beam search procedure. In some examples, the NDP frame format 1200 or the NDP frame format 1201 may be used for a BRP in a beam search procedure, such as a BRP of a beam search procedure described with reference to FIGS. 6 and 8, and some other transmitter BRPs. In some examples, fields other than the repeated LTFs 1204 for beam scanning, such as the STF 1202, the SIG 1206, and an LTF 1204 right before the SIG 1206 for demodulation, may be heavily boosted or use a sectional transmitter/receiver to improve detection performance. For example, these techniques may enable detection and reception of the NDP frame having the NDP frame format 1200 or the NDP frame format 1201 in channel conditions with lower signal quality or channel quality. In some examples, the fields other than the repeated LTFs 1204 may be transmitted using the available best transmit-receive beam pair.

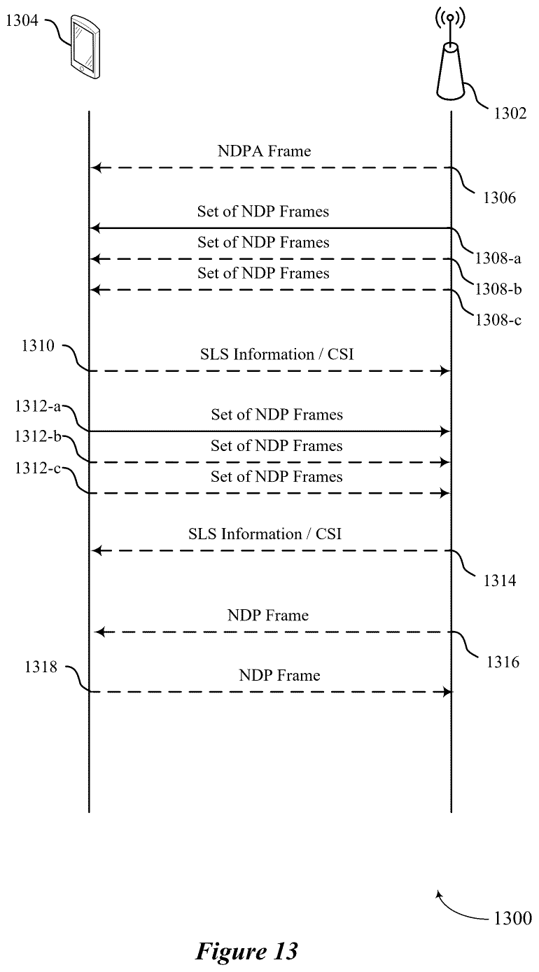

FIG. 13 shows an example of a process flow 1300 that supports 60 GHz NDP sounding. The process flow 1300 may implement, or be implemented by, aspects of FIGS. 1-12. For example, an initiator device (such as, an AP 1302) and a responder device (such as, a STA 1304), which may be examples of corresponding devices described with reference to FIGS. 1-12, may perform wireless communications in accordance with the process flow 1300.

The AP 1302 and the STA 1304 may perform a sounding procedure via a wireless channel that is associated with a 60 GHz communication band. The AP 1302 and the STA 1304 may communicate NDP frames to perform the sounding procedure. NDP frame formats for the NDP frames may correspond to one or more PPDU frame formats or NDP frame formats described herein. The sounding procedure via the wireless channel associated with the 60 GHz communication band may be used for analog beam training and digital beamforming channel sounding. In some examples, the sounding procedure may implement aspects of, or be implemented by, a beam search procedure or a beam scanning procedure, or both, described herein. For example, the sounding procedure may include a SLS procedure performed by the initiator device and an SLS procedure performed by the responder device. In some examples, the sounding procedure may include a BRP, such as if the sounding procedure includes 1D beam scanning as described herein.

In some examples, the AP 1302 may output, and the STA 1304 may receive, an NDPA frame at 1306. For example, the AP 1302 may output the NDPA frame that indicates the sounding procedure for the first wireless channel associated with the 60 GHz communication band. In some examples, the AP 1302 may output the NDPA frame via the first wireless channel associated with the 60 GHz communication band. In some other examples, the AP 1302 may output the NDPA frame via a second wireless channel associated with a sub-7 GHz communication band. In some examples, a beam search procedure which includes communication of the NDPA frame via the second wireless channel associated with the sub-7 GHz communication band may be referred to as a sub-7 GHz assisted beam search procedure. Examples of sub-7 GHz assisted beam search procedures are described in more detail with reference to FIGS. 6 and 7. A beam search procedure which does not include communication of the NDPA frame via the second wireless channel associated with the sub-7 GHz communication band may be referred to as a non-sub-7 GHz assisted beam search procedure. Examples of non-sub-7 GHz assisted beam search procedure are described in more detail with reference to FIGS. 8 and 9.

In some examples, the NDPA frame may indicate (for example, set up) beam training parameters for the sounding procedure or a beam search procedure, or both. For example, the NDPA frame may indicate a beam search type, a beam training method, a training length, a first transmit sector identifier, a last transmit sector identifier, a first transmit antenna identifier, a last transmit antenna identifier, a receiver-side SLS length, a quantity of receiver antennas, a quantity of streams, or any combination thereof. In some examples, such as if the NDPA frame is transmitted via the second wireless channel associated with the sub-7 GHz communication band, the NDPA frame may provide a timing and frequency reference for the first wireless channel associated with the 60 GHz communication band. In some examples, the NDPA frame may have a CPHY PPDU format, a DPHY PPDU format, or an ELR PPDU format.

At 1308, the AP 1302 may output, and the STA 1304 may receive, multiple NDP frames for the sounding procedure. The AP 1302 may output the multiple NDP frames via the first wireless channel associated with the 60 GHz communication band. In some examples, the NDP frames may have a degraded CPHY format, an NDP frame format, a preamble only PPDU format as described herein, or a traditional NDP frame structure (for example, with a legacy preamble, STF, LTF, and packet extension field), or using LTF repetition in a single packet for beam scanning.

In some examples, the sounding procedure may include a beam search procedure that uses 1D beam scanning. The AP 1302 may output a first set of NDP frames that corresponds to a first set of beams of the AP 1302 for the sounding procedure. The STA 1304 may receive the first set of NDP frames using a quasi-omni directional receive beam. The STA 1304 may measure the first set of NDP frames, such as to obtain power measurements for the first set of beams of the AP 1302 or a channel measurement of the first wireless channel, or both.

In some examples, at 1310 the STA 1304 may transmit, and the AP 1302 may obtain, SLS information or CSI, or both, based on the first set of NDP frames. In some examples, the SLS information or the CSI, or both, may be communicated via an SLS/CSI report. The SLS/CSI report may indicate one or more antenna identifiers, one or more sector identifiers, and one or more SNR reports based on a quantity of spatial streams associated with the sounding procedure. For example, the SLS/CSI report may indicate a best RF chain for each spatial stream (for example, indicating one RF chain for a SISO beam search), a best antenna identifier for each spatial stream, a best sector identifier for each spatial stream, and an SNR report for each spatial stream. In some examples, a best antenna identifier may be indicated by two bits (for example, per stream), a best sector identifier may be indicated by six bits (per stream), and an SNR report may be indicated by eight bits (per stream). For a MIMO beam search procedure, the SLS/CSI report may indicate a best RF chain for each stream, indicated by two bits per stream.

At 1312, the STA 1304 may transmit, and the AP 1302 may obtain, a second set of NDP frames that corresponds to a second set of beams of the STA 1304 for the sounding procedure. For example, for the beam search procedure that includes 1D beam scanning, the STA 1304 may transmit the second set of NDP frames, and the AP 1302 may receive the second set of NDP frames using a quasi omni-directional receive beam. The AP 1302 may measure the second set of NDP frames, for example to obtain measurements of the second set of beams of the STA 1304. In some examples, one or more NDP frames of the second set of NDP frames may indicate the SLS information or the CSI, or both. For example, the SLS/CSI report may be indicated via the NDP frames of the second set of NDP frames instead of transmitting the SLS information/CSI at 1310.

In some examples, the AP 1302 may output beam information based on the second set of NDP frames at 1314. The beam information may include SLS information or CSI, or both, based on the second set of NDP frames. For example, the AP 1302 may output an SLS/CSI report indicating beam information based on the second set of NDP frames. In some examples, the beam information may indicate at least a first beam of the first set of beam of the AP 1302 or a second beam of the second set of beams of the STA 1304, or both, based on the sounding procedure.

In some examples, such as for a beam search procedure that uses 1D beam scanning, the AP 1302 and the STA 1304 may perform a BRP. For example, at 1316, the AP 1302 may output an NDP frame for the BRP. The AP 1302 may output the NDP frame at 1316 using a beam identified by the SLS/CSI report obtained at 1310. At 1318, the STA 1304 may output an NDP frame for the BRP. The STA 1304 may output the NDP frame using a beam identified by the SLS/CSI report obtained at 1314.

In some examples, the sounding procedure may include a beam search procedure that uses 2D beam scanning. For example, at 1308, the AP 1302 may output the first set of NDP frames multiple times. For example, the AP 1302 may output the first set of NDP frames multiple times based on a quantity of the second set of beams of the STA 1304. The STA 1304 may receive and measure each set of NDP frames using a different receive beam. For example, at 1308-a, the AP 1302 may output the first set of NDP frames a first time, using a different transmit beam for each NDP frame of the first set of NDP frames, and the STA 1304 may receive the first set of NDP frames at 1308-a using a first receive beam. At 1308-b, the AP 1302 may output the first set of NDP frames a second time, and the STA 1304 may receive the first set of NDP frames at 1308-b using a second receive beam. The AP 1302 may output the first set of NDP frames once for each receive beam the STA 1304 is configured to use for the sounding procedure. For example, at 1308-c, the AP 1302 may output the first set of NDP frames an Nth time, and the STA 1304 may receive the first set of NDP frames using an Nth receive beam.

For a 2D beam scanning procedure, the STA 1304 may transmit the second set of NDP frames multiple times at 1312. For example, at 1312-a, the STA 1304 may transmit the second set of NDP frames for a first time, and the AP 1302 may receive the second set of NDP frames at 1312-a using a first receive beam. The AP 1302 may receive the second set of NDP frames at 1312-b using a second receive beam and receive the second set of NDP frames at 1312-c an Mth time using an Mth receive beam.

The AP 1302 or the STA 1304, or both, may communicate NDP frames via at least portions of a bandwidth of the first wireless channel. In some examples, a transmitting device, such as the AP 1302 or the STA 1304, may transmit an NDP frame over an entire data PPDU bandwidth. For example, the NDP frame may populate all valid tones defined for a PPDU bandwidth mode. In some examples, the transmitting device may transmit an NDP frame over a subband or base frequency block of a data PPDU bandwidth. In some examples, the transmitting device may transmit an NDP frame over an entire data PPDU bandwidth but populating distributed (for example, sparse) tones.

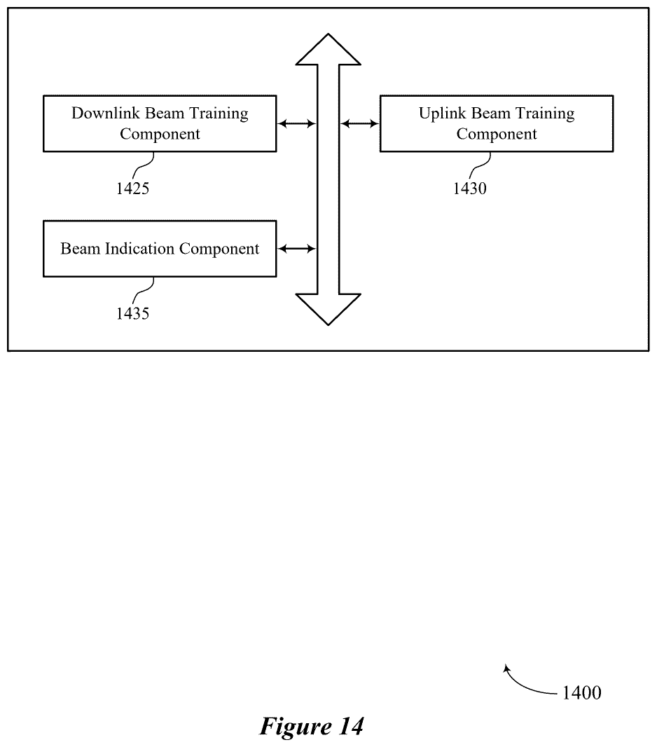

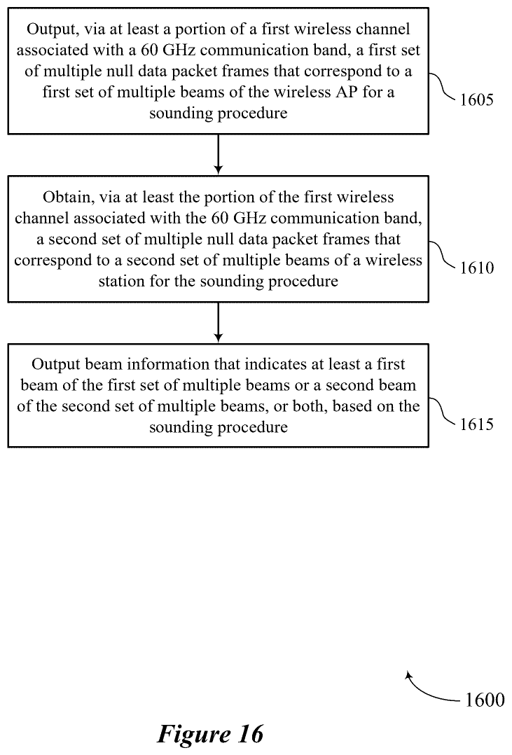

FIG. 14 shows a block diagram of an example wireless communication device 1400 that supports 60 GHz NDP sounding. In some examples, the wireless communication device 1400 is configured to perform the processes 1600, 1700, and 1800 described with reference to FIGS. 16, 17, and 18, respectively. The wireless communication device 1400 may include one or more chips, SoCs, chipsets, packages, components or devices that individually or collectively constitute or include a processing system. The processing system may interface with other components of the wireless communication device 1400, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1400 may transmit the information output from the chip. In such an example, the second interface may refer to an interface between the processing system of the chip and a reception component, such that the wireless communication device 1400 may receive information that is then passed to the processing system. In some such examples, the first interface also may obtain information, such as from the transmission component, and the second interface also may output information, such as to the reception component.

The processing system of the wireless communication device 1400 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1400 can be configurable or configured for use in an AP, such as the AP 102 described with reference to FIG. 1. In some other examples, the wireless communication device 1400 can be an AP that includes such a processing system and other components including multiple antennas. The wireless communication device 1400 is capable of transmitting and receiving wireless communications in the form of, for example, wireless packets. For example, the wireless communication device 1400 can be configurable or configured to transmit and receive packets in the form of physical layer PPDUs and MPDUs conforming to one or more of the IEEE 802.11 family of wireless communication protocol standards. In some other examples, the wireless communication device 1400 can be configurable or configured to transmit and receive signals and communications conforming to one or more 3GPP specifications including those for 5G NR or 6G. In some examples, the wireless communication device 1400 also includes or can be coupled with one or more application processors which may be further coupled with one or more other memories. In some examples, the wireless communication device 1400 further includes at least one external network interface coupled with the processing system that enables communication with a core network or backhaul network that enables the wireless communication device 1400 to gain access to external networks including the Internet.

The wireless communication device 1400 includes a downlink beam training component 1425, an uplink beam training component 1430, and a beam indication component 1435. Portions of one or more of the downlink beam training component 1425, the uplink beam training component 1430, and the beam indication component 1435 may be implemented at least in part in hardware or firmware. For example, one or more of the downlink beam training component 1425, the uplink beam training component 1430, and the beam indication component 1435 may be implemented at least in part by at least a processor or a modem. In some examples, portions of one or more of the downlink beam training component 1425, the uplink beam training component 1430, and the beam indication component 1435 may be implemented at least in part by a processor and software in the form of processor-executable code stored in memory.

The wireless communication device 1400 may support wireless communications in accordance with examples as disclosed herein. The downlink beam training component 1425 is configurable or configured to output, via at least a portion of a first wireless channel associated with a 60 GHz communication band, a first set of multiple NDP frames that correspond to a first set of multiple beams of the wireless AP for a sounding procedure. The uplink beam training component 1430 is configurable or configured to obtain, via at least the portion of the first wireless channel associated with the 60 GHz communication band, a second set of multiple NDP frames that correspond to a second set of multiple beams of a wireless station for the sounding procedure. The beam indication component 1435 is configurable or configured to output beam information that indicates at least a first beam of the first set of multiple beams or a second beam of the second set of multiple beams, or both, based on the sounding procedure.

In some examples, the downlink beam training component 1425 is configurable or configured to output an NDPA frame that indicates the sounding procedure.

In some examples, the downlink beam training component 1425 is configurable or configured to output a beam training request via a second wireless channel of a sub-7 GHz communication band. The downlink beam training component 1425 may be configurable or configured to obtain a beam training response via the second wireless channel of the sub-7 GHz communication band responsive to the beam training request, where the null data packet announcement frame is output in accordance with the beam training response.

In some examples, a format of the NDPA frame corresponds to an ELR PPDU format. In some examples, the NDPA frame may provide a timing reference or a frequency reference, or both, for the first wireless communications channel.

In some examples, to support outputting the NDPA frame, the downlink beam training component 1425 is configurable or configured to output the NDPA frame via a second wireless channel associated with a sub-7 GHz communication band.

In some examples, to support outputting the NDPA frame, the downlink beam training component 1425 is configurable or configured to output the NDPA frame via the first wireless channel associated with the 60 GHz communication band.

In some examples, the first set of multiple NDP frames are output after a time delay from output of the NDPA frame.

In some examples, the downlink beam training component 1425 is configurable or configured to obtain an acknowledgment message responsive to the NDPA frame, where the first set of multiple NDP frames are output after a delay from a receipt of the acknowledgment message.

In some examples, the NDPA frame indicates a beam search type, a beam training method, a training length, a first transmit sector identifier, a last transmit sector identifier, a first transmit antenna identifier, a last transmit antenna identifier, a receiver-side SLS length, a quantity of receiver antennas, a quantity of streams, or any combination thereof.

In some examples, an NDP frame of the first set of multiple NDP frames or the second set of multiple NDP frames includes one or more long training fields.

In some examples, an NDP frame of the first set of multiple NDP frames or the second set of multiple NDP frames includes a signal field and one or more long training fields.

In some examples, the beam indication component 1435 is configurable or configured to output, via a second wireless channel associated with a sub-7 GHz communication band, a feedback trigger based on output of the first set of multiple NDP frames. In some examples, the beam indication component 1435 is configurable or configured to obtain second beam information that indicates the first beam of the first set of multiple beams in response to the feedback trigger.

In some examples, to support outputting the first set of multiple NDP frames, the downlink beam training component 1425 is configurable or configured to output the first set of multiple NDP frames using each beam of the first set of multiple beams a set of multiple times based on a quantity of the second set of multiple beams of the wireless station. In some examples, to support outputting the first set of multiple NDP frames, the uplink beam training component 1430 is configurable or configured to obtain the second set of multiple NDP frames using each beam of the first set of multiple beams of the wireless AP.

In some examples, the beam indication component 1435 is configurable or configured to output, after an output of the first set of multiple NDP frames, a feedback trigger. In some examples, the beam indication component 1435 is configurable or configured to obtain second beam information that indicates the first beam of the first set of multiple beams.

In some examples, one or more parameters for the sounding procedure are indicated in a signal field of each NDP in the first set of multiple NDP frames.

In some examples, the one or more parameters includes a beam search type, a beam training method, a training length, a countdown, a first transmit sector identifier, a last transmit sector identifier, a first transmit antenna identifier, a last transmit antenna identifier, a receiver-side SLS length, a quantity of receiver antennas, a quantity of streams, or any combination thereof.

In some examples, an NDP frame of the first set of multiple NDP frames or the second set of multiple NDP frames includes one or more L-STF, one or more L-LTF, one or more IMMW-SIG fields, one or more U-SIG fields, one or more training fields, a packet extension field, or any combination thereof.

In some examples, the beam information indicates one or more antenna identifier, one or more sector identifiers, and one or more signal-to-noise ratio report based on a quantity of spatial streams associated with the sounding procedure.

In some examples, the first set of multiple NDP frames are output over all valid tones of a data PPDU bandwidth, a subband of the data PPDU bandwidth, or distributed tones of the data PPDU bandwidth.

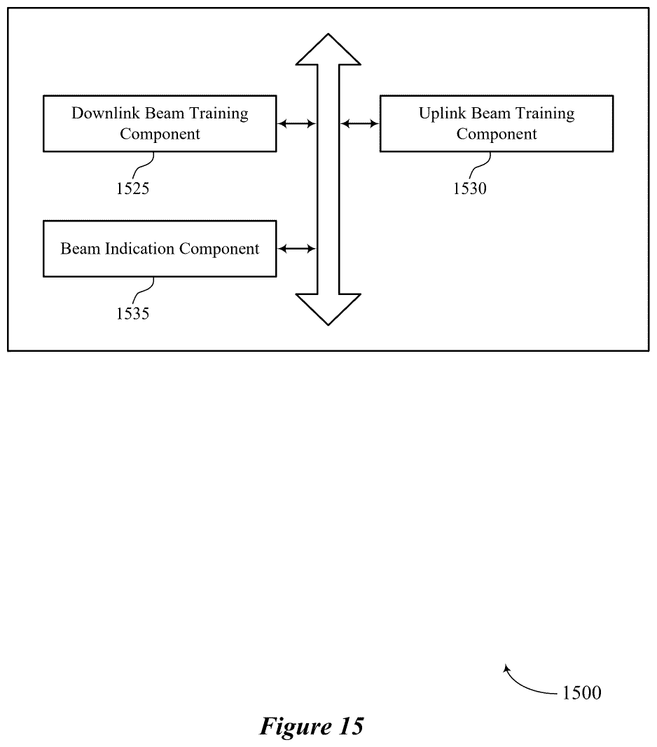

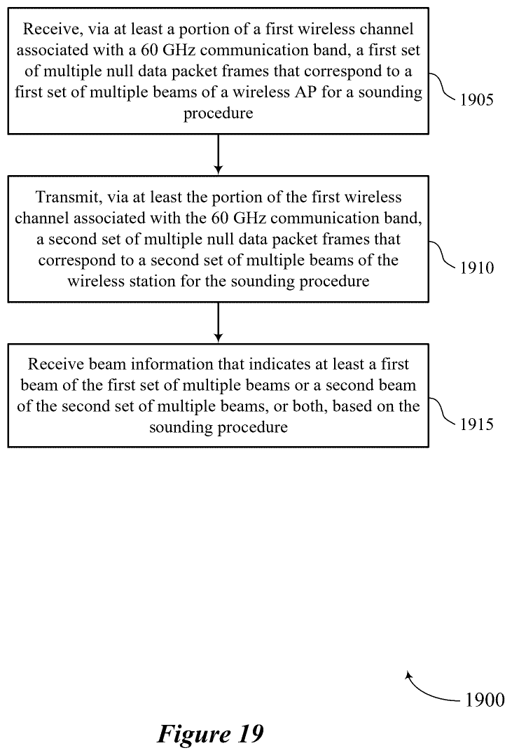

FIG. 15 shows a block diagram of an example wireless communication device 1500 that supports 60 GHz NDP sounding. In some examples, the wireless communication device 1500 is configured to perform the process 1900 described with reference to FIG. 19. The wireless communication device 1500 may include one or more chips, SoCs, chipsets, packages, components or devices that individually or collectively constitute or include a processing system. The processing system may interface with other components of the wireless communication device 1500, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1500 may transmit the information output from the chip. In such an example, the second interface may refer to an interface between the processing system of the chip and a reception component, such that the wireless communication device 1500 may receive information that is then passed to the processing system. In some such examples, the first interface also may obtain information, such as from the transmission component, and the second interface also may output information, such as to the reception component.

The processing system of the wireless communication device 1500 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1500 can be configurable or configured for use in a STA, such as the STA 104 described with reference to FIG. 1. In some other examples, the wireless communication device 1500 can be a STA that includes such a processing system and other components including multiple antennas. The wireless communication device 1500 is capable of transmitting and receiving wireless communications in the form of, for example, wireless packets. For example, the wireless communication device 1500 can be configurable or configured to transmit and receive packets in the form of physical layer PPDUs and MPDUs conforming to one or more of the IEEE 802.11 family of wireless communication protocol standards. In some other examples, the wireless communication device 1500 can be configurable or configured to transmit and receive signals and communications conforming to one or more 3GPP specifications including those for 5G NR or 6G. In some examples, the wireless communication device 1500 also includes or can be coupled with one or more application processors which may be further coupled with one or more other memories. In some examples, the wireless communication device 1500 further includes a user interface (UI) (such as a touchscreen or keypad) and a display, which may be integrated with the UI to form a touchscreen display that is coupled with the processing system. In some examples, the wireless communication device 1500 may further include one or more sensors such as, for example, one or more inertial sensors, accelerometers, temperature sensors, pressure sensors, or altitude sensors, that are coupled with the processing system.

The wireless communication device 1500 includes a downlink beam training component 1525, an uplink beam training component 1530, and a beam indication component 1535. Portions of one or more of the downlink beam training component 1525, the uplink beam training component 1530, and the beam indication component 1535 may be implemented at least in part in hardware or firmware. For example, one or more of the downlink beam training component 1525, the uplink beam training component 1530, and the beam indication component 1535 may be implemented at least in part by at least a processor or a modem. In some examples, portions of one or more of the downlink beam training component 1525, the uplink beam training component 1530, and the beam indication component 1535 may be implemented at least in part by a processor and software in the form of processor-executable code stored in memory.

The wireless communication device 1500 may support wireless communications in accordance with examples as disclosed herein. The downlink beam training component 1525 is configurable or configured to receive, via at least a portion of a first wireless channel associated with a 60 GHz communication band, a first set of multiple NDP frames that correspond to a first set of multiple beams of a wireless access point (AP) for a sounding procedure. The uplink beam training component 1530 is configurable or configured to transmit, via at least the portion of the first wireless channel associated with the 60 GHz communication band, a second set of multiple NDP frames that correspond to a second set of multiple beams of the wireless station for the sounding procedure. The beam indication component 1535 is configurable or configured to receive beam information that indicates at least a first beam of the first set of multiple beams or a second beam of the second set of multiple beams, or both, based on the sounding procedure.

In some examples, the downlink beam training component 1525 is configurable or configured to receive an NDPA frame that indicates the sounding procedure. In some examples, a format of the NDPA frame corresponds to an ELR PPDU format.

In some examples, the downlink beam training component 1525 is configurable or configured to receive a beam training request via a second wireless channel of a sub-7 GHz communication band. The downlink beam training component 1525 may be configurable or configured to transmit a beam training response via the second wireless channel of the sub-7 GHz communication band responsive to the beam training request, where the null data packet announcement frame is received in accordance with the beam training response.

In some examples, to support receiving the NDPA frame, the downlink beam training component 1525 is configurable or configured to receive the NDPA frame via a second wireless channel associated with a sub-7 GHz communication band.

In some examples, to support receiving the NDPA frame, the downlink beam training component 1525 is configurable or configured to receive the NDPA frame via the first wireless channel associated with the 60 GHz communication band.

In some examples, the first set of multiple NDP frames are received after a time delay from reception of the NDPA frame.

In some examples, to support receiving the NDPA frame, the downlink beam training component 1525 is configurable or configured to receive an acknowledgment message responsive to the NDPA frame, where the first set of multiple NDP frames are received after a delay from the acknowledgment message.

In some examples, the NDPA frame indicates a beam search type, a beam training method, a training length, a first transmit sector identifier, a last transmit sector identifier, a first transmit antenna identifier, a last transmit antenna identifier, a receiver-side SLS length, a quantity of receiver antennas, a quantity of streams, or any combination thereof.

In some examples, an NDP frame of the first set of multiple NDP frames or the second set of multiple NDP frames includes one or more long training fields.

In some examples, an NDP frame of the first set of multiple NDP frames or the second set of multiple NDP frames includes a signal field and one or more long training fields.

In some examples, the beam indication component 1535 is configurable or configured to receive, via a second wireless channel associated with a sub-7 GHz communication band, a feedback trigger based on transmission of the first set of multiple NDP frames. In some examples, the beam indication component 1535 is configurable or configured to transmit second beam information that indicates the first beam of the first set of multiple beams in response to the feedback trigger.

In some examples, to support receiving the first set of multiple NDP frames, the downlink beam training component 1525 is configurable or configured to receive the first set of multiple NDP frames using each beam of the second set of multiple beams. In some examples, to support receiving the first set of multiple NDP frames, the uplink beam training component 1530 is configurable or configured to transmit the second set of multiple NDP frames a set of multiple times based on a quantity of the first set of multiple beams of the wireless AP each beam of the second set of multiple beams of the wireless station.

In some examples, the beam indication component 1535 is configurable or configured to receive, after a reception of the first set of multiple NDP frames, a feedback trigger. In some examples, the beam indication component 1535 is configurable or configured to transmit second beam information that indicates the first beam of the first set of multiple beams.

In some examples, one or more parameters for the sounding procedure are indicated in a signal field of each NDP in the first set of multiple NDP frames.

In some examples, the one or more parameters includes a beam search type, a beam training method, a training length, a countdown, a first transmit sector identifier, a last transmit sector identifier, a first transmit antenna identifier, a last transmit antenna identifier, a receiver-side SLS length, a quantity of receiver antennas, a quantity of streams, or any combination thereof.

In some examples, an NDP frame of the first set of multiple NDP frames or the second set of multiple NDP frames includes one or more L-STF, one or more legacy L-LTF, one or more IMMW-SIG fields, one or more U-SIG fields, one or more training fields, a packet extension field, or any combination thereof.

In some examples, the beam information indicates one or more antenna identifier, one or more sector identifiers, and one or more signal-to-noise ratio report based on a quantity of spatial streams associated with the sounding procedure.

In some examples, the first set of multiple NDP frames are output over all valid tones of a data physical layer protocol data unit (PPDU) bandwidth, a subband of the data PPDU bandwidth, or distributed tones of the data PPDU bandwidth.

FIG. 16 shows a flowchart illustrating an example process 1600 performable by or at a wireless AP that supports 60 GHz NDP sounding. The operations of the process 1600 may be implemented by a wireless AP or its components as described herein. For example, the process 1600 may be performed by a wireless communication device, such as the wireless communication device 1400 described with reference to FIG. 14, operating as or within a wireless AP. In some examples, the process 1600 may be performed by a wireless AP, such as one of the APs 102 described with reference to FIG. 1.

In some examples, in 1605, the wireless AP may output, via at least a portion of a first wireless channel associated with a 60 GHz communication band, a first set of multiple NDP frames that correspond to a first set of multiple beams of the wireless AP for a sounding procedure. In some implementations, aspects of the operations of 1605 may be performed by a downlink beam training component 1425 as described with reference to FIG. 14.

In some examples, in 1610, the wireless AP may obtain, via at least the portion of the first wireless channel associated with the 60 GHz communication band, a second set of multiple NDP frames that correspond to a second set of multiple beams of a wireless station for the sounding procedure. In some implementations, aspects of the operations of 1610 may be performed by an uplink beam training component 1430 as described with reference to FIG. 14.

In some examples, in 1615, the wireless AP may output beam information that indicates at least a first beam of the first set of multiple beams or a second beam of the second set of multiple beams, or both, based on the sounding procedure. In some implementations, aspects of the operations of 1615 may be performed by a beam indication component 1435 as described with reference to FIG. 14.

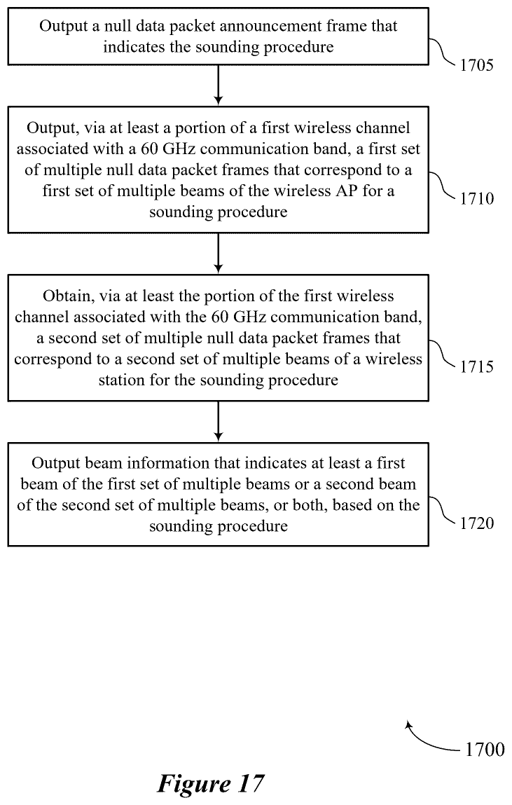

FIG. 17 shows a flowchart illustrating an example process 1700 performable by or at a wireless AP that supports 60 GHz NDP sounding. The operations of the process 1700 may be implemented by a wireless AP or its components as described herein. For example, the process 1700 may be performed by a wireless communication device, such as the wireless communication device 1400 described with reference to FIG. 14, operating as or within a wireless AP. In some examples, the process 1700 may be performed by a wireless AP, such as one of the APs 102 described with reference to FIG. 1.

In some examples, in 1705, the wireless AP may output an NDPA frame that indicates the sounding procedure. In some implementations, aspects of the operations of 1705 may be performed by a downlink beam training component 1425 as described with reference to FIG. 14.

In some examples, in 1710, the wireless AP may output, via at least a portion of a first wireless channel associated with a 60 GHz communication band, a first set of multiple NDP frames that correspond to a first set of multiple beams of the wireless AP for a sounding procedure. In some implementations, aspects of the operations of 1710 may be performed by a downlink beam training component 1425 as described with reference to FIG. 14.

In some examples, in 1715, the wireless AP may obtain, via at least the portion of the first wireless channel associated with the 60 GHz communication band, a second set of multiple NDP frames that correspond to a second set of multiple beams of a wireless station for the sounding procedure. In some implementations, aspects of the operations of 1715 may be performed by an uplink beam training component 1430 as described with reference to FIG. 14.

In some examples, in 1720, the wireless AP may output beam information that indicates at least a first beam of the first set of multiple beams or a second beam of the second set of multiple beams, or both, based on the sounding procedure. In some implementations, aspects of the operations of 1720 may be performed by a beam indication component 1435 as described with reference to FIG. 14.

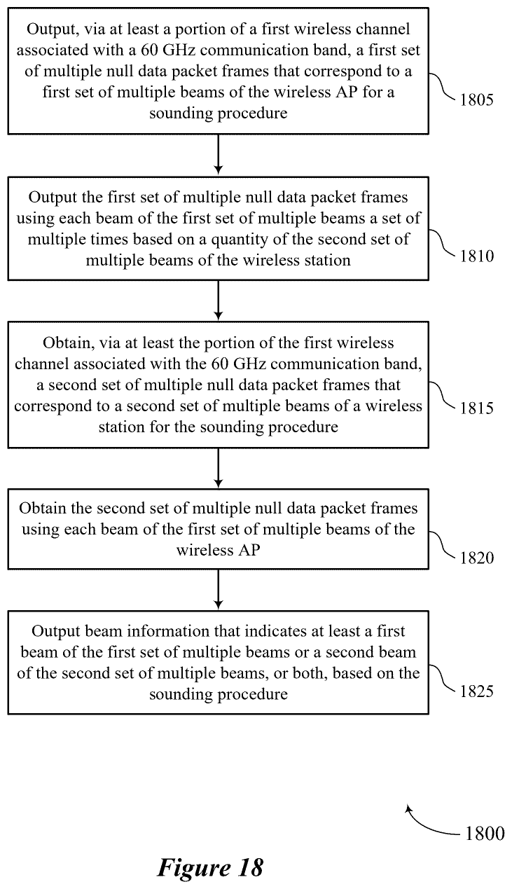

FIG. 18 shows a flowchart illustrating an example process 1800 performable by or at a wireless AP that supports 60 GHz NDP sounding. The operations of the process 1800 may be implemented by a wireless AP or its components as described herein. For example, the process 1800 may be performed by a wireless communication device, such as the wireless communication device 1400 described with reference to FIG. 14, operating as or within a wireless AP. In some examples, the process 1800 may be performed by a wireless AP, such as one of the APs 102 described with reference to FIG. 1.

In some examples, in 1805, the wireless AP may output, via at least a portion of a first wireless channel associated with a 60 GHz communication band, a first set of multiple NDP frames that correspond to a first set of multiple beams of the wireless AP for a sounding procedure. In some implementations, aspects of the operations of 1805 may be performed by a downlink beam training component 1425 as described with reference to FIG. 14.

In some examples, in 1810, the wireless AP may output the first set of multiple NDP frames using each beam of the first set of multiple beams a set of multiple times based on a quantity of the second set of multiple beams of the wireless station. In some implementations, aspects of the operations of 1810 may be performed by an uplink beam training component 1430 as described with reference to FIG. 14.

In some examples, in 1815, the wireless AP may obtain, via at least the portion of the first wireless channel associated with the 60 GHz communication band, a second set of multiple NDP frames that correspond to a second set of multiple beams of a wireless station for the sounding procedure. In some implementations, aspects of the operations of 1815 may be performed by an uplink beam training component 1430 as described with reference to FIG. 14.

In some examples, in 1820, the wireless AP may obtain the second set of multiple NDP frames using each beam of the first set of multiple beams of the wireless AP. In some implementations, aspects of the operations of 1820 may be performed by an uplink beam training component 1430 as described with reference to FIG. 14.

In some examples, in 1825, the wireless AP may output beam information that indicates at least a first beam of the first set of multiple beams or a second beam of the second set of multiple beams, or both, based on the sounding procedure. In some implementations, aspects of the operations of 1825 may be performed by a beam indication component 1435 as described with reference to FIG. 14.

FIG. 19 shows a flowchart illustrating an example process 1900 performable by or at a wireless station that supports 60 GHz NDP sounding. The operations of the process 1900 may be implemented by a wireless station or its components as described herein. For example, the process 1900 may be performed by a wireless communication device, such as the wireless communication device 1500 described with reference to FIG. 15, operating as or within a wireless STA. In some examples, the process 1900 may be performed by a wireless STA, such as one of the STAs 104 described with reference to FIG. 1.

In some examples, in 1905, the wireless station may receive, via at least a portion of a first wireless channel associated with a 60 GHz communication band, a first set of multiple NDP frames that correspond to a first set of multiple beams of a wireless AP for a sounding procedure. In some implementations, aspects of the operations of 1905 may be performed by a downlink beam training component 1525 as described with reference to FIG. 15.

In some examples, in 1910, the wireless station may transmit, via at least the portion of the first wireless channel associated with the 60 GHz communication band, a second set of multiple NDP frames that correspond to a second set of multiple beams of the wireless station for the sounding procedure. In some implementations, aspects of the operations of 1910 may be performed by an uplink beam training component 1530 as described with reference to FIG. 15.

In some examples, in 1915, the wireless station may receive beam information that indicates at least a first beam of the first set of multiple beams or a second beam of the second set of multiple beams, or both, based on the sounding procedure. In some implementations, aspects of the operations of 1915 may be performed by a beam indication component 1535 as described with reference to FIG. 15.

Implementation examples are described in the following numbered clauses:

The following provides an overview of aspects of the present disclosure:
Aspect 1: A method for wireless communications at a wireless AP, comprising: outputting, via at least a portion of a first wireless channel associated with a 60 GHz communication band, a first plurality of null data packet frames that correspond to a first plurality of beams of the wireless AP for a sounding procedure; obtaining, via at least the portion of the first wireless channel associated with the 60 GHz communication band, a second plurality of null data packet frames that correspond to a second plurality of beams of a wireless station for the sounding procedure; and outputting beam information that indicates at least a first beam of the first plurality of beams or a second beam of the second plurality of beams, or both, based at least in part on the sounding procedure.
Aspect 2: The method of aspect 1, further comprising: outputting a null data packet announcement frame that indicates the sounding procedure.
Aspect 3: The method of aspect 2, wherein outputting the null data packet announcement frame comprises: outputting the null data packet announcement frame via a second wireless channel associated with a sub-7 GHz communication band.
Aspect 4: The method of any of aspects 2 through 3, wherein outputting the null data packet announcement frame comprises: outputting the null data packet announcement frame via the first wireless channel associated with the 60 GHz communication band.
Aspect 5: The method of any of aspects 2 through 4, wherein the first plurality of null data packet frames are output after a time delay from output of the null data packet announcement frame.
Aspect 6: The method of any of aspects 2 through 5, further comprising: obtaining an acknowledgment message responsive to the null data packet announcement frame, wherein the first plurality of null data packet frames are output after a delay from a receipt of the acknowledgment message.
Aspect 7: The method of any of aspects 2 through 6, wherein the null data packet announcement frame indicates a beam search type, a beam training method, a training length, a first transmit sector identifier, a last transmit sector identifier, a first transmit antenna identifier, a last transmit antenna identifier, a receiver-side sector-level sweep (SLS) length, a quantity of receiver antennas, a quantity of streams, or any combination thereof.
Aspect 8: The method of any of aspects 2 through 7, wherein a format of the null data packet announcement frame corresponds to an extended long range (ELR) PPDU format
Aspect 9: The method of any of aspects 2 through 8, further comprising: communicating a beam training request via a second wireless channel of a sub-7 GHz communication band; and communicating a beam training response via the second wireless channel of the sub-7 GHz communication band responsive to the beam training request, wherein the null data packet announcement frame is output in accordance with the beam training response.
Aspect 10: The method of any of aspects 1 through 9, wherein a null data packet frame of the first plurality of null data packet frames or the second plurality of null data packet frames comprises one or more long training fields.
Aspect 11: The method of any of aspects 1 through 10, wherein a null data packet frame of the first plurality of null data packet frames or the second plurality of null data packet frames comprises a signal field and one or more long training fields.
Aspect 12: The method of any of aspects 1 through 11, further comprising: outputting, via a second wireless channel associated with a sub-7 GHz communication band, a feedback trigger based at least in part on output of the first plurality of null data packet frames; and obtaining second beam information that indicates the first beam of the first plurality of beams in response to the feedback trigger.
Aspect 13: The method of any of aspects 1 through 12, wherein outputting the first plurality of null data packet frames comprises: outputting the first plurality of null data packet frames using each beam of the first plurality of beams a plurality of times based at least in part on a quantity of the second plurality of beams of the wireless station; and obtaining the second plurality of null data packet frames using each beam of the first plurality of beams of the wireless AP.
Aspect 14: The method of aspect 13, further comprising: outputting, after an output of the first plurality of null data packet frames, a feedback trigger; and obtaining second beam information that indicates the first beam of the first plurality of beams.
Aspect 15: The method of any of aspects 1 through 14, wherein one or more parameters for the sounding procedure are indicated in a signal field of each null data packet in the first plurality of null data packet frames.
Aspect 16: The method of aspect 15, wherein the one or more parameters comprises a beam search type, a beam training method, a training length, a countdown, a first transmit sector identifier, a last transmit sector identifier, a first transmit antenna identifier, a last transmit antenna identifier, a receiver-side SLS length, a quantity of receiver antennas, a quantity of streams, or any combination thereof.
Aspect 17: The method of any of aspects 1 through 16, wherein a null data packet frame of the first plurality of null data packet frames or the second plurality of null data packet frames comprises one or more L-STF, one or more L-LTF, one or more IMMW-SIG fields, one or more U-SIG fields, one or more training fields, a packet extension field, or any combination thereof.
Aspect 18: The method of any of aspects 1 through 17, wherein the beam information indicates one or more antenna identifier, one or more sector identifiers, and one or more signal-to-noise ratio report based at least in part on a quantity of spatial streams associated with the sounding procedure.
Aspect 19: The method of any of aspects 1 through 18, wherein the first plurality of null data packet frames are output over all valid tones of a data physical layer PPDU bandwidth, a subband of the data PPDU bandwidth, or distributed tones of the data PPDU bandwidth.
Aspect 20: A method for wireless communications at a wireless station, comprising: receiving, via at least a portion of a first wireless channel associated with a 60 GHz communication band, a first plurality of null data packet frames that correspond to a first plurality of beams of a wireless AP for a sounding procedure; transmitting, via at least the portion of the first wireless channel associated with the 60 GHz communication band, a second plurality of null data packet frames that correspond to a second plurality of beams of the wireless station for the sounding procedure; and receiving beam information that indicates at least a first beam of the first plurality of beams or a second beam of the second plurality of beams, or both, based at least in part on the sounding procedure.
Aspect 21: The method of aspect 20, further comprising: receiving a null data packet announcement frame that indicates the sounding procedure.
Aspect 22: The method of aspect 21, wherein receiving the null data packet announcement frame comprises: receiving the null data packet announcement frame via a second wireless channel associated with a sub-7 GHz communication band.
Aspect 23: The method of any of aspects 21 through 22, wherein receiving the null data packet announcement frame comprises: receiving the null data packet announcement frame via the first wireless channel associated with the 60 GHz communication band.
Aspect 24: The method of any of aspects 21 through 23, wherein the first plurality of null data packet frames are received after a time delay from reception of the null data packet announcement frame.
Aspect 25: The method of any of aspects 21 through 24, further comprising: receiving an acknowledgment message responsive to the null data packet announcement frame, wherein the first plurality of null data packet frames are received after a delay from the acknowledgment message.
Aspect 26: The method of any of aspects 21 through 25, further comprising: communicating a beam training request via a second wireless channel of a sub-7 GHz communication band; and communicating a beam training response via the second wireless channel of the sub-7 GHz communication band responsive to the beam training request, wherein the null data packet announcement frame is received in accordance with the beam training response.
Aspect 27: The method of any of aspects 21 through 26, wherein the null data packet announcement frame indicates a beam search type, a beam training method, a training length, a first transmit sector identifier, a last transmit sector identifier, a first transmit antenna identifier, a last transmit antenna identifier, a receiver-side SLS length, a quantity of receiver antennas, a quantity of streams, or any combination thereof.
Aspect 28: The method of any of aspects 20 through 27, wherein a null data packet frame of the first plurality of null data packet frames or the second plurality of null data packet frames comprises one or more long training fields.
Aspect 29: The method of any of aspects 20 through 28, wherein a null data packet frame of the first plurality of null data packet frames or the second plurality of null data packet frames comprises a signal field and one or more long training fields.
Aspect 30: The method of any of aspects 20 through 29, further comprising: receiving, via a second wireless channel associated with a sub-7 GHz communication band, a feedback trigger based at least in part on transmission of the first plurality of null data packet frames; and transmitting second beam information that indicates the first beam of the first plurality of beams in response to the feedback trigger.
Aspect 31: The method of any of aspects 20 through 30, wherein receiving the first plurality of null data packet frames comprises: receiving the first plurality of null data packet frames using each beam of the second plurality of beams; and transmitting the second plurality of null data packet frames a plurality of times based at least in part on a quantity of the first plurality of beams of the wireless AP each beam of the second plurality of beams of the wireless station.
Aspect 32: The method of aspect 31, further comprising: receiving, after a reception of the first plurality of null data packet frames, a feedback trigger; and transmitting second beam information that indicates the first beam of the first plurality of beams.
Aspect 33: The method of any of aspects 20 through 32, wherein one or more parameters for the sounding procedure are indicated in a signal field of each null data packet in the first plurality of null data packet frames.
Aspect 34: The method of aspect 33, wherein the one or more parameters comprises a beam search type, a beam training method, a training length, a countdown, a first transmit sector identifier, a last transmit sector identifier, a first transmit antenna identifier, a last transmit antenna identifier, a receiver-side SLS length, a quantity of receiver antennas, a quantity of streams, or any combination thereof.
Aspect 35: The method of any of aspects 20 through 34, wherein a null data packet frame of the first plurality of null data packet frames or the second plurality of null data packet frames comprises one or more L-STF, one or more L-LTF, one or more IMMW-SIG fields, one or more U-SIG fields, one or more training fields, a packet extension field, or any combination thereof.
Aspect 36: The method of any of aspects 20 through 35, wherein the beam information indicates one or more antenna identifier, one or more sector identifiers, and one or more signal-to-noise ratio report based at least in part on a quantity of spatial streams associated with the sounding procedure.
Aspect 37: The method of any of aspects 20 through 36, wherein the first plurality of null data packet frames are output over all valid tones of a data physical layer PPDU bandwidth, a subband of the data PPDU bandwidth, or distributed tones of the data PPDU bandwidth.
Aspect 38: A wireless AP for wireless communications, comprising a processing system that includes processor circuitry and memory circuitry that stores code, the processing system configured to cause the wireless AP to perform a method of any of aspects 1 through 19.
Aspect 39: A wireless AP for wireless communications, comprising at least one means for performing a method of any of aspects 1 through 19.
Aspect 40: A non-transitory computer-readable medium storing code for wireless communications, the code comprising instructions executable by one or more processors to perform a method of any of aspects 1 through 19.
Aspect 41: A wireless station for wireless communications, comprising a processing system that includes processor circuitry and memory circuitry that stores code, the processing system configured to cause the wireless station to perform a method of any of aspects 20 through 37.
Aspect 42: A wireless station for wireless communications, comprising at least one means for performing a method of any of aspects 20 through 37.
Aspect 43: A non-transitory computer-readable medium storing code for wireless communications, the code comprising instructions executable by one or more processors to perform a method of any of aspects 20 through 37.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless access point (AP), comprising:
a processing system that includes processor circuitry and memory circuitry that stores code, the processing system configured to cause the wireless AP to:
output, via at least a portion of a first wireless channel associated with a 60 GHz communication band, a first plurality of null data packet frames that correspond to a first plurality of beams of the wireless AP for a sounding procedure;
obtain, via at least the portion of the first wireless channel associated with the 60 GHz communication band, a second plurality of null data packet frames that correspond to a second plurality of beams of a wireless station for the sounding procedure; and
output beam information that indicates at least a first beam of the first plurality of beams or a second beam of the second plurality of beams, or both, based at least in part on the sounding procedure.

2. The wireless AP of claim 1, wherein the processing system is further configured to cause the wireless AP to:
output a null data packet announcement frame that indicates the sounding procedure.

3. The wireless AP of claim 2, wherein, to output the null data packet announcement frame, the processing system is configured to cause the wireless AP to:
output the null data packet announcement frame via a second wireless channel associated with a sub-7 GHz communication band.

4. The wireless AP of claim 2, wherein, to output the null data packet announcement frame, the processing system is configured to cause the wireless AP to:
output the null data packet announcement frame via the first wireless channel associated with the 60 GHz communication band.

5. The wireless AP of claim 2, wherein the first plurality of null data packet frames are output after a time delay from output of the null data packet announcement frame.

6. The wireless AP of claim 2, wherein the processing system is further configured to cause the wireless AP to:
obtain an acknowledgment message responsive to the null data packet announcement frame, wherein the first plurality of null data packet frames are output after a delay from a receipt of the acknowledgment message.

7. The wireless AP of claim 2, wherein the null data packet announcement frame indicates a beam search type, a beam training method, a training length, a first transmit sector identifier, a last transmit sector identifier, a first transmit antenna identifier, a last transmit antenna identifier, a receiver-side sector-level sweep (SLS) length, a quantity of receiver antennas, a quantity of streams, or any combination thereof.

8. The wireless AP of claim 2, wherein a format of the null data packet announcement frame corresponds to an extended long range (ELR) physical layer protocol data unit (PPDU) format.

9. The wireless AP of claim 2, wherein the processing system is configured to cause the wireless AP to:
communicate a beam training request via a second wireless channel of a sub-7 GHz communication band; and
communicate a beam training response via the second wireless channel of the sub-7 GHz communication band responsive to the beam training request, wherein the null data packet announcement frame is output in accordance with the beam training response.

10. The wireless AP of claim 1, wherein:
a null data packet frame of the first plurality of null data packet frames or the second plurality of null data packet frames comprises one or more long training fields.

11. The wireless AP of claim 1, wherein a null data packet frame of the first plurality of null data packet frames or the second plurality of null data packet frames comprises a signal field and one or more long training fields.

12. The wireless AP of claim 1, wherein the processing system is further configured to cause the wireless AP to:
output, via a second wireless channel associated with a sub-7 GHz communication band, a feedback trigger based at least in part on output of the first plurality of null data packet frames; and
obtain second beam information that indicates the first beam of the first plurality of beams in response to the feedback trigger.

13. The wireless AP of claim 1, wherein, to output the first plurality of null data packet frames, the processing system is configured to cause the wireless AP to:
output the first plurality of null data packet frames using each beam of the first plurality of beams a plurality of times based at least in part on a quantity of the second plurality of beams of the wireless station; and
obtain the second plurality of null data packet frames using each beam of the first plurality of beams of the wireless AP.

14. The wireless AP of claim 13, wherein the processing system is further configured to cause the wireless AP to:
output, after an output of the first plurality of null data packet frames, a feedback trigger; and
obtain second beam information that indicates the first beam of the first plurality of beams.

15. The wireless AP of claim 1, wherein one or more parameters for the sounding procedure are indicated in a signal field of each null data packet in the first plurality of null data packet frames.

16. The wireless AP of claim 1, wherein a null data packet frame of the first plurality of null data packet frames or the second plurality of null data packet frames comprises one or more legacy short training fields (L-STF), one or more legacy long training fields (L-LTF), one or more integrated millimeter wave signal (IMMW-SIG) fields, one or more universal signal (U-SIG) fields, one or more training fields, a packet extension field, or any combination thereof.

17. The wireless AP of claim 1, wherein the first plurality of null data packet frames are output over all valid tones of a data physical layer protocol data unit (PPDU) bandwidth, a subband of the data PPDU bandwidth, or distributed tones of the data PPDU bandwidth.

18. A method for wireless communications at a wireless access point (AP), comprising:
outputting, via at least a portion of a first wireless channel associated with a 60 GHz communication band, a first plurality of null data packet frames that correspond to a first plurality of beams of the wireless AP for a sounding procedure;
obtaining, via at least the portion of the first wireless channel associated with the 60 GHz communication band, a second plurality of null data packet frames that correspond to a second plurality of beams of a wireless station for the sounding procedure; and
outputting beam information that indicates at least a first beam of the first plurality of beams or a second beam of the second plurality of beams, or both, based at least in part on the sounding procedure.

19. The method of claim 18, further comprising:
outputting a null data packet announcement frame that indicates the sounding procedure.

20. The method of claim 19, wherein outputting the null data packet announcement frame further comprises:
outputting the null data packet announcement frame via a second wireless channel associated with a sub-7 GHz communication band.

21. The method of claim 19, wherein outputting the null data packet announcement frame further comprises:
outputting the null data packet announcement frame via the first wireless channel associated with the 60 GHz communication band.

22. The method of claim 19, wherein the first plurality of null data packet frames are output after a time delay from output of the null data packet announcement frame.

23. The method of claim 19, further comprising:
obtain an acknowledgment message responsive to the null data packet announcement frame, wherein the first plurality of null data packet frames are output after a delay from a receipt of the acknowledgment message.

24. The method of claim 19, further comprising:
communicating a beam training request via a second wireless channel of a sub-7 GHz communication band; and
communicating a beam training response via the second wireless channel of the sub-7 GHz communication band responsive to the beam training request, wherein the null data packet announcement frame is output in accordance with the beam training response.

25. The method of claim 18, wherein a null data packet frame of the first plurality of null data packet frames or the second plurality of null data packet frames comprises one or more long training fields.

26. The method of claim 18, further comprising:
outputting, via a second wireless channel associated with a sub-7 GHz communication band, a feedback trigger based at least in part on output of the first plurality of null data packet frames; and
obtaining second beam information that indicates the first beam of the first plurality of beams in response to the feedback trigger.

27. The method of claim 18, wherein outputting the first plurality of null data packet frames further comprises:
outputting the first plurality of null data packet frames using each beam of the first plurality of beams a plurality of times based at least in part on a quantity of the second plurality of beams of the wireless station; and
obtaining the second plurality of null data packet frames using each beam of the first plurality of beams of the wireless AP.

28. The method of claim 18, further comprising:
outputting, after an output of the first plurality of null data packet frames, a feedback trigger; and
obtaining second beam information that indicates the first beam of the first plurality of beams.

29. A wireless access point (AP), comprising:
means for outputting, via at least a portion of a first wireless channel associated with a 60 GHz communication band, a first plurality of null data packet frames that correspond to a first plurality of beams of the wireless AP for a sounding procedure;
means for obtaining, via at least the portion of the first wireless channel associated with the 60 GHz communication band, a second plurality of null data packet frames that correspond to a second plurality of beams of a wireless station for the sounding procedure; and
means for outputting beam information that indicates at least a first beam of the first plurality of beams or a second beam of the second plurality of beams, or both, based at least in part on the sounding procedure.

30. A non-transitory computer-readable medium storing code for wireless communications at a wireless access point (AP), the code comprising instructions executable by one or more processors to:
output, via at least a portion of a first wireless channel associated with a 60 GHz communication band, a first plurality of null data packet frames that correspond to a first plurality of beams of the wireless AP for a sounding procedure;
obtain, via at least the portion of the first wireless channel associated with the 60 GHz communication band, a second plurality of null data packet frames that correspond to a second plurality of beams of a wireless station for the sounding procedure; and
output beam information that indicates at least a first beam of the first plurality of beams or a second beam of the second plurality of beams, or both, based at least in part on the sounding procedure.
